(19) United States
(12) Patent Application Publication
(10) Pub. No.: US 2025/0334781 A1
(43) Pub. Date: Oct. 30, 2025

(54) IMAGING OPTICAL SYSTEM, PROJECTION TYPE DISPLAY DEVICE, AND IMAGING APPARATUS

(71) Applicant: FUJIFILM Corporation, Tokyo (JP)

(72) Inventors: Masaru AMANO, Saitama (JP); Akiko NAGAHARA, Saitama (JP); Ukyo TOMIOKA, Saitama (JP); Takashi KUNUGISE, Saitama (JP); Taku FURUBAYASHI, Saitama (JP)

(73) Assignee: FUJIFILM Corporation, Tokyo (JP)

(21) Appl. No.: 19/174,510

(22) Filed: Apr. 9, 2025

(30) Foreign Application Priority Data
Apr. 25, 2024 (JP) 2024-071744

(51) Int. Cl. G02B 17/08; G02B 13/16

(52) U.S. Cl. CPC G02B 17/08; G02B 13/16

(57) ABSTRACT

An imaging optical system including a reflective optical system and a refractive optical system including plural lenses along an optical path in order from an enlargement side to a reduction side, wherein: the reflective optical system includes a first reflecting surface having a positive power, a second reflecting surface having a power, and a third reflecting surface having a positive power along the optical path in order from the enlargement side to the reduction side, an intermediate image conjugate to an image on a reduction-side imaging plane is formed twice on the optical path between the refractive optical system and an enlargement-side imaging plane, the intermediate image is re-formed on the enlargement-side imaging plane, the imaging optical system further includes a focusing group, and the first, second, and the third reflecting surface are fixed to the reduction-side imaging plane during focusing.

### CROSS-REFERENCE TO RELATED APPLICATIONS

This application claims priority from Japanese Application No. 2024-071744, filed on Apr. 25, 2024, the entire disclosure of which is incorporated herein by reference.

### BACKGROUND

### Technical Field

The present disclosed technology relates to an imaging optical system, a projection type display device, and an imaging apparatus.

### Related Art

In the related art, as an imaging optical system that can be used in a projection type display device, an imaging apparatus, or the like, systems described in JP2020-024359A and JP2020-086174A are known.

There has been a demand for an imaging optical system having a wide angle, has a reduced variation in aberrations during focusing, and has a high optical performance while achieving a reduction in size. A level of the demand has increased year by year.

### SUMMARY

The present disclosure provides an imaging optical system having a wide angle, has a reduced variation in aberrations during focusing, and has a high optical performance while achieving a reduction in size, a projection type display device including the imaging optical system, and an imaging apparatus including the imaging optical system.

According to one aspect of the present disclosure, there is provided an imaging optical system comprising a reflective optical system and a refractive optical system including a plurality of lenses along an optical path in order from an enlargement side to a reduction side, in which the reflective optical system includes a first reflecting surface having a positive power, a second reflecting surface having a power, and a third reflecting surface having a positive power along the optical path in order from the enlargement side to the reduction side, an intermediate image conjugate to an image on a reduction-side imaging plane is formed twice on the optical path between a surface closest to the enlargement side in the refractive optical system and an enlargement-side imaging plane, the intermediate image is re-formed on the enlargement-side imaging plane, the imaging optical system further includes a focusing group consisting of a lens that moves during focusing from a long range to a short range, and the first reflecting surface, the second reflecting surface, and the third reflecting surface are fixed to the reduction-side imaging plane during focusing from a long range to a short range.

In a case where the intermediate image closest to the reduction side among the intermediate images is a first intermediate image, a position where an off-axis principal ray and an optical axis intersect each other in the refractive optical system is a stop position, and a focusing group closest to the enlargement side among focusing groups disposed from the first intermediate image to the stop position is a F1 focusing group, it is preferable that the F1 focusing group moves from the enlargement side to the reduction side during focusing from a long range to a short range.

It is preferable that the imaging optical system further includes: at least one of a F2A focusing group that is the focusing group closest to the enlargement side among the focusing groups and is disposed closer to the enlargement side than the first reflecting surface, or a F2B focusing group that is the focusing group closest to the reduction side among the focusing groups and is disposed closer to the reduction side than the F1 focusing group.

It is preferable that, in a case where a focal length of the F2B focusing group is represented by fF2B, and a focal length of the refractive optical system is represented by f2, Conditional Expression (1) represented by

$$1 < \vert fF 2 B / f 2 \vert < 20 \qquad ( 1 )$$

is satisfied.

It is preferable that a lens surface closest to the enlargement side in the F2B focusing group has a shape having a convex surface facing the enlargement side.

It is preferable that, in a case where a lens surface closest to the reduction side in the F2B focusing group is disposed closer to the enlargement side than the stop position, the F2B focusing group moves from the enlargement side to the reduction side during focusing from a long range to a short range, in a case where a lens surface closest to the enlargement side in the F2B focusing group is disposed adjacent to the reduction side at the stop position, the F2B focusing group moves from the reduction side to the enlargement side during focusing from a long range to a short range, and in a case where the lens surface closest to the enlargement side in the F2B focusing group is disposed closer to the reduction side than the stop position and at least one lens that is fixed to the reduction-side imaging plane during focusing from a long range to a short range is disposed between the stop position and the surface closest to the enlargement side in the F2B focusing group, the F2B focusing group moves from the enlargement side to the reduction side during focusing from a long range to a short range.

It is preferable that, in a case where a combined focal length from a surface closest to the enlargement side in the imaging optical system to a surface closest to the reduction side in the reflective optical system is represented by f1, and a focal length of the F2A focusing group is represented by fF2A, Conditional Expression (2) represented by

$$0 < \vert f 1 / fF 2 A \vert < 1 \qquad ( 2 )$$

is satisfied.

It is preferable that the F2A focusing group is disposed closest to the enlargement side in the imaging optical system.

It is preferable that the F2A focusing group consists of one single lens.

It is preferable that a lens surface of the single lens on the enlargement side has an aspherical shape having a convex surface facing the enlargement side.

It is preferable that a lens surface closest to the enlargement side in the F1 focusing group has a shape having a concave surface facing the enlargement side in a paraxial region.

It is preferable that the lens surface closest to the enlargement side in the F1 focusing group has an aspherical shape including a region where a negative power is weakened away from the optical axis.

It is preferable that, in a case where a focal length of the refractive optical system is represented by f2, and a focal length of the F1 focusing group is represented by fF1, Conditional Expression (3) represented by

$$- 2 < f 2 / fF 1 < 0.5 \qquad ( 3 )$$

is satisfied.

It is preferable that, in a case where a maximum half angle of view of the enlargement side is represented by ω, Conditional Expression (4) represented by

$$3.6 < tan ω \qquad ( 4 )$$

is satisfied.

It is preferable that the second reflecting surface has a negative power.

It is preferable that a first intermediate image is formed on the optical path between the third reflecting surface and the refractive optical system, and a second intermediate image is formed on the optical path between the first reflecting surface and the second reflecting surface.

It is preferable that, in a case where a focal length of the imaging optical system is represented by f, and a combined focal length from a surface closest to the enlargement side in the imaging optical system to a surface closest to the reduction side in the reflective optical system is represented by f1, Conditional Expression (5) represented by

$$1 < \vert f 1 / f \vert < 10 \qquad ( 5 )$$

is satisfied.

The imaging optical system may comprise only two focusing groups.

According to another aspect of the present disclosure, there is provided a projection type display device including the imaging optical system according to the above-described aspect.

According to still another aspect of the present disclosure, there is provided an imaging apparatus including the imaging optical system according to the above-described aspect.

In the present specification, it should be noted that the terms “consisting of” and “consists of” mean that the lens may include not only the above-described components but also lenses substantially having no power, optical elements, which are not lenses, such as a stop, a mask, a filter, a cover glass, a plane mirror, and a prism, and mechanism parts such as a lens flange, a lens barrel, an imaging element, and a camera shaking correction mechanism.

“Focusing group” is not limited to consisting of a plurality of lenses, and may consist of only one lens. “Single lens” means one uncemented lens. The number of lenses described above is the number of lenses as components. For example, it is assumed that the number of lenses in a cemented lens in which a plurality of single lenses made of different materials are cemented is represented by the number of single lenses constituting the cemented lens.

Here, a compound aspherical lens (that is, a lens in which a spherical lens and an aspherical film formed on the spherical lens are integrally formed and function as one aspherical lens as a whole) is not regarded as cemented lenses, but the compound aspherical lens is regarded as one lens. The sign of the power and the surface shape relating to an optical member including an aspheric surface are considered in a paraxial region unless otherwise specified.

The “focal length” used in a conditional expression is a paraxial focal length. Unless otherwise specified, values used in the conditional expressions are values based on the d line in the state where the infinite distance object is in focus. The “d line”, “C line”, and “F line” described in the present specification are emission lines, the wavelength of the d line is 587.56 nanometers (nm), the wavelength of the C line is 656.27 nanometers (nm), and the wavelength of the F line is 486.13 nanometers (nm).

The present disclosure can provide an imaging optical system having a wide angle, has a reduced variation in aberrations during focusing, and has a high optical performance while achieving a reduction in size, a projection type display device including the imaging optical system, and an imaging apparatus including the imaging optical system.

### BRIEF DESCRIPTION OF THE DRAWINGS

FIG. 1 is a cross-sectional view showing a configuration and luminous fluxes of an imaging optical system according to an embodiment corresponding to an imaging optical system according to Example 1.

FIG. 2 shows each of aberration diagrams in the imaging optical system according to Example 1.

FIG. 3 is a cross-sectional view showing a configuration and luminous fluxes of an imaging optical system according to Example 2.

FIG. 4 shows each of aberration diagrams in the imaging optical system according to Example 2.

FIG. 5 is a cross-sectional view showing a configuration and luminous fluxes of an imaging optical system according to Example 3.

FIG. 6 shows each of aberration diagrams in the imaging optical system according to Example 3.

FIG. 7 is a cross-sectional view showing a configuration and luminous fluxes of an imaging optical system according to Example 4.

FIG. 8 shows each of aberration diagrams in the imaging optical system according to Example 4.

FIG. 9 is a cross-sectional view showing a configuration and luminous fluxes of an imaging optical system according to Example 5.

FIG. 10 shows each of aberration diagrams in the imaging optical system according to Example 5.

FIG. 11 is a cross-sectional view showing a configuration and luminous fluxes of an imaging optical system according to Example 6.

FIG. 12 shows each of aberration diagrams in the imaging optical system according to Example 6.

FIG. 13 is a cross-sectional view showing a configuration and luminous fluxes of an imaging optical system according to Example 7.

FIG. 14 shows each of aberration diagrams in the imaging optical system according to Example 7.

FIG. 15 is a schematic configuration diagram showing a projection type display device according to an embodiment.

FIG. 16 is a schematic configuration diagram showing a projection type display device according to another embodiment.

FIG. 17 is a schematic configuration diagram showing a projection type display device according to still another embodiment.

FIG. 18 is a schematic configuration diagram showing a projection type display device according to still another embodiment.

FIG. 19 is a perspective view of the front side of an imaging apparatus according to an embodiment.

FIG. 20 is a perspective view showing a rear side of the imaging apparatus shown in FIG. 19.

### DETAILED DESCRIPTION

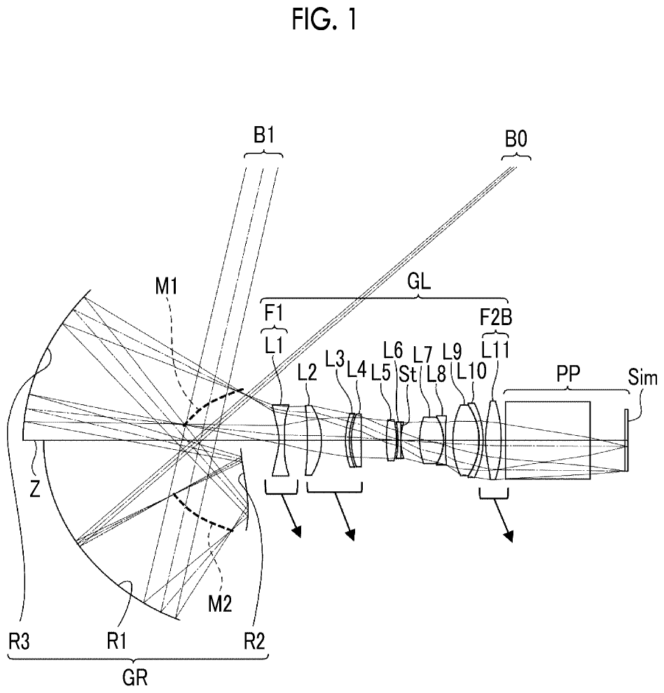

Hereinafter, an embodiment of the present disclosed technology will be described with reference to the drawings. FIG. 1 is a cross-sectional view showing a configuration and luminous fluxes in a cross section including an optical axis Z of an imaging optical system according to an embodiment of the present disclosure. The configuration example shown in FIG. 1 corresponds to Example 1 described below. In FIG. 1, as the luminous fluxes, a ray B0 with the minimum angle of view and a ray B1 with the maximum angle of view are shown.

The imaging optical system according to the present disclosure can also be mounted on a projection type display device to configure a projection optical system where a display element is disposed on a reduction-side imaging plane. In addition, the imaging optical system can also be mounted on a digital camera or the like to configure an imaging optical system where an imaging element is disposed on the reduction-side imaging plane. Hereinafter, the description will be made assuming a case where the imaging optical system according to the present disclosure is used for the projection optical system. In the following description, in order to avoid redundant description, “the imaging optical system of the present disclosure” will also be simply referred to as an “the imaging optical system”.

FIG. 1 shows an example in which an optical member PP and a display surface Sim of a light valve are disposed on a reduction side of the imaging optical system on the assumption that the imaging optical system is mounted on a projection type display device. The optical member PP is a member which is regarded as a filter, a cover glass, a color synthesis prism, or the like. The optical member PP has no power, and a configuration where the optical member PP is not provided can also be adopted. The light valve is a display element that outputs an optical image, and the optical image is displayed as an image on the display surface Sim. As the light valve, for example, a liquid crystal display element or an image display element such as digital micromirror device (DMD: registered trademark) can be used.

The imaging optical system is mounted on, for example, a projection type display device and projects an image displayed on the display surface Sim of the display element on the reduction side onto a projection surface on the enlargement side. In the projection type display device, a luminous flux provided with image information on the display surface Sim is incident into the imaging optical system through the optical member PP, and is projected onto a screen (not shown) that is a projection surface through the imaging optical system. That is, the display surface Sim and the screen are positioned at optically conjugate positions. The screen is an example of the “enlargement-side imaging plane” of the present disclosure, and the image display surface Sim is an example of the “reduction-side imaging plane” of the present disclosure. It should be noted that, in the present specification, the term “screen” means an object on which a projected image formed by the imaging optical system is projected. The screen may be, for example, not only a dedicated screen but also a wall surface of a room, a floor surface, a ceiling, an outer wall surface of a building, or the like.

In the description of the present specification, “the enlargement side” refers to the screen side on the optical path, and “the reduction side” refers to the display surface Sim side on the optical path. In the present specification, “the enlargement side” and “the reduction side” are determined along the optical path. For example, in the imaging optical system that forms a bent optical path, “a lens A is closer to the enlargement side than a lens B” has the same meaning as “the lens A is on the optical path to be closer to the enlargement side than the lens B”. Accordingly, in the imaging optical system that forms a bent optical path, “closest to the enlargement side” represents that a position is closest to the enlargement side in the arrangement order on the optical path, and does not represent that the position is closest to the screen in terms of distance. Hereinafter, in order to avoid redundant description, “along the optical path in order from the enlargement side to the reduction side” will also be referred to as “in order from the enlargement side to the reduction side”.

The imaging optical system according to the present disclosure consists of a reflective optical system GR and a refractive optical system GL including a plurality of lenses along the optical path in order from the enlargement side to the reduction side. The reflective optical system GR includes a first reflecting surface R1 having a positive power, a second reflecting surface R2 having a power, and a third reflecting surface R3 having a positive power along the optical path in order from the enlargement side to the reduction side.

Chromatic aberration does not occur on the reflecting surface itself. Therefore, by disposing three reflecting surfaces on the enlargement side in the imaging optical system, the occurrence of chromatic aberration in the entire optical system can be reduced. In addition, an optical path length can be easily ensured by the optical path where a ray is reflected three times. Therefore, the size can be reduced while achieving a wide angle, and further the power of each of optical elements can be reduced. As a result, a load on aberration correction and the like of the refractive optical system GL can be reduced, and thus the number of lenses of the refractive optical system GL can be reduced, which contributes to a reduction in size.

For example, the first reflecting surface R1, the second reflecting surface R2, and the third reflecting surface R3 of FIG. 1 consist of mirror surfaces. For example, the refractive optical system GL of FIG. 1 consists of lenses L1 to L6, an aperture stop St, and lenses L7 to L11 in order from the enlargement side to the reduction side. The aperture stop St shown in FIG. 1 does not show the size or the shape thereof, but shows a position thereof in the optical axis direction. For example, the refractive optical system GL and the reflective optical system GR of FIG. 1 have the common optical axis Z. The configuration of the coaxial system can be set up more easily than a configuration other than the coaxial system. In a case where an optical surface of an optical component has a rotational symmetrical axis, the rotational symmetrical axis corresponds to the optical axis Z.

In the imaging optical system of FIG. 1, a luminous flux from the display surface Sim to the enlargement side transmits through the optical member PP, transmits through the refractive optical system GL, and forms a first intermediate image M1. Next, the luminous flux is incident into the third reflecting surface R3 to be reflected from the third reflecting surface R3, is incident into the second reflecting surface R2 to be reflected from the second reflecting surface R2, and forms a second intermediate image M2. Next, the luminous flux is incident into the first reflecting surface R1 to be reflected from the first reflecting surface R1, and forms a projected image on the screen (not shown). In FIG. 1, the first intermediate image M1 and the second intermediate image M2 are indicated by conceptually thick broken lines. The shape of the first intermediate image M1 and the second intermediate image M2 shown in FIG. 1 is not necessarily accurate.

In the imaging optical system according to the present disclosure, an intermediate image conjugate to an image on a reduction-side imaging plane (for example, an image displayed on the display surface Sim) is formed twice on the optical path between a surface closest to the enlargement side in the refractive optical system GL and an enlargement-side imaging plane, and the intermediate image is re-formed on the enlargement-side imaging plane. By forming the intermediate images in the imaging optical system, the focal length of the entire system can be reduced to achieve a configuration suitable for increasing the angle of view. In particular, by forming the two intermediate images on the optical path between the surface closest to the enlargement side in the refractive optical system GL and the enlargement-side imaging plane, this configuration is advantageous in increasing the angle of view and achieving a reduction in size and an increase in performance. In a case where an intermediate image is formed three or more times, this configuration is disadvantageous in reducing the size.

Specifically, the first intermediate image M1 is formed at a position conjugate to the reduction-side imaging plane on the optical path between the third reflecting surface R3 and the refractive optical system GL. The second intermediate image M2 is formed at a position conjugate to the first intermediate image M1 on the optical path between the first reflecting surface R1 and the second reflecting surface R2. By not forming an intermediate image on the first reflecting surface R1, the second reflecting surface R2, and the third reflecting surface R3 in the refractive optical system GL, projection of scratches and/or dust of a lens and/or a reflecting surface can be suppressed, which is advantageous in forming a favorable projected image.

The imaging optical system according to the present disclosure further includes a focusing group consisting of a lens that moves during focusing from a long range to a short range. In addition, in the imaging optical system according to the present disclosure, the first reflecting surface R1, the second reflecting surface R2, and the third reflecting surface R3 are fixed to the reduction-side imaging plane during focusing from a long range to a short range. “During focusing from a long range to a short range” refers to during a change in projection distance (that is, a distance on the optical axis from a surface closest to the enlargement side in the imaging optical system to the enlargement-side imaging plane) from a long range to a short range.

By fixing the first reflecting surface R1, the second reflecting surface R2, and the third reflecting surface R3 and moving a lens during focusing, a variation in field curvature and a variation in distortion during focusing can be suppressed while improving the manufacturability. In a case where the first reflecting surface R1, the second reflecting surface R2, and/or the third reflecting surface R3 moves during focusing, it is difficult to suppress a variation in field curvature and a variation in distortion during focusing. The reason for this is that a reflecting surface has a higher error sensitivity than a typical lens, and a performance change caused by a small error (here, a collapse and/or off-axis component) in position during focusing is likely to increase.

For example, the imaging optical system of FIG. 1 includes a F1 focusing group F1 consisting of a lens L1, a focusing group consisting of lenses L2 to L4, and a F2B focusing group F2B consisting of a lens L11. These focusing groups move along the optical axis Z to perform focusing, and the other lenses and reflecting surfaces are fixed to the reduction-side imaging plane. In FIG. 1, a parenthesis and an arrow indicating a schematic moving direction of each of the focusing groups during focusing from a long range to a short range are filled in below the lenses corresponding to the focusing group. In the drawings of the present application, a plurality of lenses shown in one parenthesis attached to an arrow indicating movement move integrally. “Move integrally” represents moving at the same time in the same direction by the same amount.

The intermediate image closest to the reduction side among the intermediate images in the imaging optical system is the first intermediate image M1, a position where an off-axis principal ray and the optical axis Z intersect each other in the refractive optical system GL is a stop position, and a focusing group closest to the enlargement side among focusing groups disposed from the first intermediate image M1 to the stop position is the F1 focusing group F1 . In this case, it is preferable that the F1 focusing group F1 moves from the enlargement side to the reduction side during focusing from a long range to a short range. In this case, a variation in field curvature and a variation in distortion caused by a change in projection distance can be suppressed.

It is preferable that a lens surface closest to the enlargement side in theF1 F1 focusing group F1 has a shape having a concave surface facing the enlargement side in a paraxial region. In this case, the surface of the F1 focusing group F1 where a luminous flux is the highest is the concave surface, which is advantageous in correcting field curvature.

It is preferable that the lens surface closest to the enlargement side in the F1 focusing group F1 has an aspherical shape including a region where a negative power is weakened away from the optical axis Z. In this case, this configuration is more advantageous in correcting field curvature.

It is preferable that the imaging optical system according to the present disclosure includes at least one of a F2A focusing group F2A that is the focusing group closest to the enlargement side among the focusing groups and is disposed closer to the enlargement side than the first reflecting surface R1, or a F2B focusing group F2B that is the focusing group closest to the reduction side among the focusing groups and is disposed closer to the reduction side than the F1 focusing group F1 . In a case where the imaging optical system includes the F2A focusing group F2A, the effect of correcting a variation in field curvature and a variation in distortion during focusing can be improved. In a case where the imaging optical system includes the F2B focusing group F2B, the F2B focusing group F2B can correct a change in focus occurring in the F1 focusing group F1 , which is advantageous in suppressing a variation in field curvature and a variation in distortion during focusing in the entire optical system.

In a case where the imaging optical system includes the F2B focusing group F2B, it is preferable that a lens surface closest to the enlargement side in the F2B focusing group F2B has a shape having a convex surface facing the enlargement side. In this case, this configuration is advantageous in correcting the focus.

In a case where the imaging optical system includes the F2B focusing group F2B, it is preferable that a moving direction of the F2B focusing group during focusing satisfies at least one of the following three configurations. First, in a case where a lens surface closest to the reduction side in the F2B focusing group F2B is disposed closer to enlargement side than the stop position, it is preferable that the F2B focusing group F2B moves from the enlargement side to the reduction side during focusing from a long range to a short range. This configuration corresponds to Example 2 and Example 5 described below.

Second, in a case where a lens surface closest to the enlargement side in the F2B focusing group F2B is disposed adjacent to the reduction side at the stop position, it is preferable that the F2B focusing group F2B moves from the reduction side to the enlargement side during focusing from a long range to a short range. This configuration corresponds to Example 3, Example 4, and Example 6 described below.

Third, in a case where the lens surface closest to the enlargement side in the F2B focusing group F2B is disposed closer to the reduction side than the stop position and at least one lens that is fixed to the reduction-side imaging plane during focusing from a long range to a short range is disposed between the stop position and the surface closest to the enlargement side in the F2B focusing group F2B, it is preferable that the F2B focusing group F2B moves from the enlargement side to the reduction side during focusing from a long range to a short range. This configuration corresponds to Example 1 described below.

The moving direction of the F2B focusing group F2B during focusing is determined to satisfy at least one of the configurations. As a result, the correction of focus and the suppression of a variation in aberrations caused by a change in projection distance can be achieved with a good balance.

In a case where the imaging optical system includes the F2A focusing group F2A, it is preferable that the F2A focusing group F2A is disposed closest to the enlargement side in the imaging optical system. By allowing the lens closest to the enlargement side in the imaging optical system to be movable during focusing, the effect of correcting a variation in distortion during focusing can be improved.

In a case where the imaging optical system includes the F2A focusing group F2A, it is preferable that the F2A focusing group F2A consists of one single lens. By allowing the number of lenses in the F2A focusing group F2A to be at least one, cost reduction can be achieved. Further, it is preferable that a lens surface of the single lens on the enlargement side in the F2A focusing group F2A has an aspherical shape having a convex surface facing the enlargement side. In this case, the effect of correcting a variation in distortion during focusing can be improved.

It is preferable that the second reflecting surface R2 has a negative power. In this case, an increase in the size of the optical system closer to the enlargement side than the second reflecting surface R2 can be suppressed, which is advantageous in reducing the size of the entire optical system.

The imaging optical system according to the present disclosure may include only two focusing groups. In this case, the simple configuration can be achieved while suppressing a variation in aberrations caused by a change in projection distance, which can contribute to cost reduction.

On the other hand, the imaging optical system according to the present disclosure may include three or more focusing groups. In this case, this configuration is advantageous in suppressing a variation in various aberrations caused by a change in projection distance.

In the imaging optical system according to the present disclosure, it is preferable that the reduction side is telecentric. In a projection type display device that outputs a high-definition image, a three-plate system is adopted, and favorable telecentricity is required. In addition, in recent years, in order to achieve a small-sized high-definition projection type display device, a so-called pixel shift system in which a resolution of 2 times or 4 times the number of pixels of the display element is achieved by shifting the pixels has been increased. In order to ensure the resolution at this time, it is desirable to use a telecentric optical system.

It should be noted that “the reduction side is telecentric” includes an error that is practically allowed in the technical field to which the present disclosed technology belongs. The error may be, for example, in a range in which the angle between an optical axis Z and a principal ray incident on the reduction-side imaging plane in a case where ray tracing is performed from the enlargement side to the reduction side is −3 degrees or more and +3 degrees or less. In a system that does not include the aperture stop St, in a case where luminous fluxes are seen in a direction from the enlargement side to the reduction side, the telecentricity may be determined by using, as a substitute for the principal ray, an angle bisector between the maximum ray on the upper side and the maximum ray on the lower side in a cross section of a luminous flux focused on any point on the reduction-side imaging plane.

Next, preferable and possible configurations about conditional expressions of the imaging optical system according to the present disclosure will be described. In the following description relating to the conditional expressions, in order to avoid redundant description, factors having the same definition will be represented by the same symbols, and the description thereof will not be repeated.

In a case where the imaging optical system includes the F2B focusing group F2B, it is preferable that the imaging optical system satisfies Conditional Expression (1). Here, a focal length of the F2B focusing group F2B is represented by fF2B, and a focal length of the refractive optical system GL is represented by f2. By setting the corresponding value of Conditional Expression (1) not to be the lower limit value or less, the power of the F2B focusing group F2B is not excessively strong for the refractive optical system GL. Therefore, the correction of focus and the suppression of a variation in aberrations caused by a change in projection distance can be achieved with a good balance. By setting the corresponding value of Conditional Expression (1) not to be the upper limit value or more, the power of the F2B focusing group F2B is not excessively weak for the refractive optical system GL. Therefore, the amount of movement of the F2B focusing group F2B during focusing can be reduced, which is advantageous in reducing the size of the entire optical system.

$$1 < \vert fF 2 B / f 2 \vert < 20 \qquad ( 1 )$$

In order to obtain more favorable characteristics, it is preferable that the lower limit value of Conditional expression (1) is any of 1.2, 1.4, 1.55, 1.7, or 1.8. In order to obtain more favorable characteristics, it is preferable that the upper limit value of Conditional expression (1) is any of 15, 10, 8.2, 7, or 6.

In a case where the imaging optical system includes the F2A focusing group F2A, it is preferable that the imaging optical system satisfies Conditional Expression (2). Here, a combined focal length from a surface closest to the enlargement side in the imaging optical system to a surface closest to the reduction side in the reflective optical system GR is represented by f1, and a focal length of the F2A focusing group F2A is represented by fF2A. That is, in a case where a lens is not disposed closer to the enlargement side than the reflective optical system GR as in Examples 1 and 2 described below, a focal length of the reflective optical system GR is represented by f1. On the other hand, in a case where a lens is disposed closer to the enlargement side than the reflective optical system GR as in Examples 3 to 7 described below, a combined focal length of the reflective optical system GR and all of the lenses closer to the enlargement side than the reflective optical system GR is represented by f1.

By setting the corresponding value of Conditional Expression (2) not to be the lower limit value or less, the power of the F2A focusing group F2A is not excessively weak for the optical system from the surface closest to the enlargement side in the imaging optical system to the surface closest to the reduction side in the reflective optical system GR. Therefore, the effect of correcting a variation in field curvature and a variation in distortion during focusing can be ensured. By setting the corresponding value of Conditional Expression (2) not to be the upper limit value or more, the power of the F2A focusing group F2A is not excessively strong for the optical system from the surface closest to the enlargement side in the imaging optical system to the surface closest to the reduction side in the reflective optical system GR. Therefore, it is easy to suppress a variation in various aberrations (in particular field curvature and distortion) during focusing.

$$0 < \vert f 1 / fF 2 A \vert < 1 \qquad ( 2 )$$

In order to obtain more favorable characteristics, it is preferable that the lower limit value of Conditional expression (2) is any of 0.005, 0.007, 0.01, 0.015, or 0.018. In order to obtain more favorable characteristics, it is preferable that the upper limit value of Conditional expression (2) is any of 0.5, 0.3, 0.2, 0.1, or 0.05.

In a case where a focal length of the F1 focusing group F1 is represented by fF1, it is preferable that the imaging optical system satisfies Conditional Expression (3). By setting the corresponding value of Conditional Expression (3) not to be the lower limit value or less, the power of the F1 focusing group F1 in the refractive optical system GL is not excessively strong. Therefore, a variation in field curvature and a variation in distortion caused by a change in projection distance can be suppressed. By setting the corresponding value of Conditional Expression (3) not to be the upper limit value or more, the power of the F1 focusing group F1 in the refractive optical system GL is not excessively strong. Therefore, a variation in field curvature and a variation in distortion caused by a change in projection distance is easily suppressed.

$$- 2 < f 2 / fF 1 < 0.5 \qquad ( 3 )$$

In order to obtain more favorable characteristics, it is preferable that the lower limit value of Conditional expression (3) is any of −1.5, −1.2, −1, or 0.9. In order to obtain more favorable characteristics, it is preferable that the upper limit value of Conditional expression (3) is any of 0.3, 0.2, 0.1, or 0.05.

In a case where a maximum half angle of view of the enlargement side is represented by ω, it is preferable that the imaging optical system satisfies Conditional Expression (4). ω represents the maximum angle among angles between the optical axis Z and a principal ray from a surface closest to the enlargement side in the imaging optical system to the enlargement-side imaging plane. By setting the corresponding value of Conditional Expression (4) not to be the lower limit value or less, an ultra-wide-angle optical system can be realized.

$$3.6 < tan ω \qquad ( 4 )$$

In order to obtain more favorable characteristics, it is preferable that the lower limit value of Conditional expression (4) is any of 3.8, 4, 4.2, or 4.4. In order to obtain more favorable characteristics, it is preferable that the upper limit value of Conditional expression (4) is any of 12, 10, 8, or 6. By setting the corresponding value of Conditional Expression (4) not to be the upper limit value or more, an image on the enlargement-side imaging plane is likely to have a desired size. In a case where the corresponding value of Conditional expression (4) is the upper limit value or more and an image having the same size as that of a case where the corresponding value of Conditional Expression (4) is less than the upper limit value is attempted to be projected, the projection distance is very short such that for example, a projection type display device needs to be disposed to be substantially in contact with the screen, and the projection cannot be realized.

In a case where a focal length of the imaging optical system is f, it is preferable that the imaging optical system satisfies Conditional Expression (5). By setting the corresponding value of Conditional Expression (5) not to be the lower limit value or less, the power of the optical system from the surface closest to the enlargement side in the imaging optical system to the surface closest to the reduction side in the reflective optical system GR is not excessively strong for the entire imaging optical system. Therefore, a balance between an increase in angle of view and each of the aberrations can be favorably maintained. By setting the corresponding value of Conditional Expression (5) not to be the upper limit value or more, the power of the optical system from the surface closest to the enlargement side in the imaging optical system to the surface closest to the reduction side in the reflective optical system GR is not excessively weak for the entire imaging optical system, which is advantageous in reducing the size of the entire optical system.

$$1 < \vert f 1 / f \vert < 10 \qquad ( 5 )$$

In order to obtain more favorable characteristics, it is preferable that the lower limit value of Conditional expression (5) is any of 1.3, 1.6, 1.8, or 1.9. In order to obtain more favorable characteristics, it is preferable that the upper limit value of Conditional expression (5) is any of 8, 6, 5, or 4.5.

In a case where the imaging optical system includes the F2A focusing group F2A, it is preferable that the F2A focusing group F2A includes a LF2A lens satisfying Conditional Expression (6). Here, a refractive index of the LF2A lens with respect to the d line is represented by NF2A, and an Abbe number of the LF2A lens with respect to the d line is represented by vF2A. By setting the corresponding value of Conditional Expression (6) not to be the lower limit value or less, a material other than a material having a low refractive index and a low Abbe number can be selected, and thus lateral chromatic aberration is easily corrected. By setting the corresponding value of Conditional Expression (6) not to be the upper limit value or more, a material other than a material having a high refractive index and a high Abbe number can be selected. Therefore, a material having a small specific gravity can be selected, and the weight is easily reduced.

$$2 < NF 2 A + 0. 01 \times vF 2 A < 2.14 \qquad ( 6 )$$

In order to obtain more favorable characteristics, it is preferable that the lower limit value of Conditional expression (6) is any of 2.02 or 2.04. In order to obtain more favorable characteristics, it is preferable that the upper limit value of Conditional expression (6) is any of 2.12 or 2.1.

It is preferable that the LF2A lens satisfies Conditional Expression (7). By setting the corresponding value of Conditional Expression (7) not to be the lower limit value or less, lateral chromatic aberration is easily corrected. By setting the corresponding value of Conditional Expression (7) not to be the upper limit value or more, a material having high availability can be used. Therefore, favorable correction of various aberrations other than chromatic aberration is easily achieved.

$$48 < vF 2 A < 57 \qquad ( 7 )$$

In order to obtain more favorable characteristics, it is more preferable that the lower limit value of Conditional Expression (7) is 50. In order to obtain more favorable characteristics, the upper limit value of Conditional Expression (7) is preferably 56.5.

It is preferable that the F1 focusing group F1 includes a LF1 lens satisfying Conditional Expression (8). Here, a refractive index of the LF1 lens with respect to the d line is represented by NLF1, and an Abbe number of the LF1 lens with respect to the d line is represented by vLF1. By setting the corresponding value of Conditional Expression (8) not to be the lower limit value or less, a material other than a material having a low refractive index and a low Abbe number can be selected, and thus lateral chromatic aberration is easily corrected. By setting the corresponding value of Conditional Expression (6) not to be the upper limit value or more, a material other than a material having a high refractive index and a high Abbe number can be selected. Therefore, a material having a small specific gravity can be selected, and the weight is easily reduced.

$$2 < NLF 1 + 0.01 \times vLF 1 < 2.14 \qquad ( 8 )$$

In order to obtain more favorable characteristics, it is preferable that the lower limit value of Conditional expression (8) is any of 2.02, 2.04, or 2.06. In order to obtain more favorable characteristics, it is preferable that the upper limit value of Conditional expression (8) is any of 2.12, 2.1, or 2.08.

It is preferable that the LF1 lens satisfies Conditional Expression (9). By setting the corresponding value of Conditional Expression (9) not to be the lower limit value or less, lateral chromatic aberration is easily corrected. By setting the corresponding value of Conditional Expression (9) not to be the upper limit value or more, a material having high availability can be used. Therefore, favorable correction of various aberrations other than chromatic aberration is easily achieved.

$$48 < v 1 < 57. \qquad ( 9 )$$

In order to obtain more favorable characteristics, it is more preferable that the lower limit value of Conditional Expression (9) is 50. In order to obtain more favorable characteristics, the upper limit value of Conditional Expression (9) is preferably 56.5.

The above-described preferable configurations and available configurations including the configurations relating to the conditional expressions can be freely combined, and it is preferable to appropriately selectively adopt the combination according to required specifications. The example of FIG. 1 is merely exemplary, and various modifications can be made without departing from the scope of the present disclosed technology.

For example, in the present disclosed technology, the number of lenses and the number of reflecting surfaces in the imaging optical system may be different from those in the example of FIG. 1. The reflecting surface is not limited to a mirror surface and may be, for example, a surface formed on a surface of a lens or a surface formed on a surface of a prism. The refractive optical system GL may include an optical member other than a lens. For example, the refractive optical system GL may include a plane mirror. The imaging optical system may include an optical path bending member not having a power to bend the optical path. As the optical path bending member, for example, a plane mirror or a reflecting surface of a prism can be used.

For example, one preferable aspect of the imaging optical system according to the present disclosure comprises a reflective optical system GR and a refractive optical system GL including a plurality of lenses along the optical path in order from the enlargement side to the reduction side, in which the reflective optical system GR includes a first reflecting surface R1 having a positive power, a second reflecting surface R2 having a power, and a third reflecting surface R3 having a positive power along the optical path in order from the enlargement side to the reduction side, an intermediate image conjugate to an image on a reduction-side imaging plane is formed twice on the optical path between a surface closest to the enlargement side in the refractive optical system GL and an enlargement-side imaging plane, the intermediate image is re-formed on the enlargement-side imaging plane, the imaging optical system further includes a focusing group consisting of a lens that moves during focusing from a long range to a short range, and the first reflecting surface R1, the second reflecting surface R2, and the third reflecting surface R3 are fixed to the reduction-side imaging plane during focusing from a long range to a short range.

Next, examples of the imaging optical system of the present disclosure will be described, with reference to the drawings. The reference numerals added to the components of the imaging optical system in a cross-sectional view of each of examples are used independently for each example in order to avoid complication of description and drawings due to an increase in the number of digits of the reference numerals. Therefore, even in a case where common reference numerals are added in the drawings of different examples, components do not necessarily have a common configuration.

### Example 1

FIG. 1 is a cross-sectional view of a configuration and luminous flux of an imaging optical system of Example 1, and an illustration method and a configuration thereof are as described above. Therefore, some description is not repeated herein. The imaging optical system according to Example 1 consists of a reflective optical system GR and a refractive optical system GL along the optical path in order from the enlargement side to the reduction side. The reflective optical system GR consists of a first reflecting surface R1 having a positive power, a second reflecting surface R2 having a negative power, and a third reflecting surface R3 having a positive power along the optical path in order from the enlargement side to the reduction side. The refractive optical system GL consists of lenses L1 to L6, an aperture stop St, and lenses L7 to L11 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

The imaging optical system according to Example 1 includes three focusing groups, that is, a F1 focusing group F1 consisting of a lens L1, a focusing group consisting of lenses L2 to L4, and a F2B focusing group F2B consisting of a lens L11. During focusing from a long range to a short range, the F1 focusing group F1 moves to the reduction side, the focusing group consisting of the lenses L2 to L4 moves to the reduction side, the F2B focusing group F2B moves to the reduction side, and the other lenses and reflecting surfaces and the aperture stop St are fixed to the display surface Sim.

Regarding the imaging optical system according to Example 1, Table 1 shows basic lens data, Table 2 shows specifications and variable surface spacings, and Table 3 shows aspherical coefficients.

The table of the basic lens data is described as follows. The “Sn” column shows surface numbers in a case where the surface closest to the enlargement side is the first surface and the number is increased one by one toward the reduction side. The R column shows a curvature radius of each surface. The D column shows a surface spacing between each surface and the surface adjacent to the reduction side on the optical axis. The Nd column shows a refractive index of each component with respect to the d line. The vd column shows an Abbe number of each component with respect to the d line. The column of “Nd+0.01×vd” shows the corresponding values of Conditional Expression (6) and Conditional Expression (8) of each of the lenses. “Reflecting Surface” is filled in the outside of the row corresponding to each of the reflecting surfaces.

In the table of the basic lens data, the sign of the curvature radius of a surface that is convex to the enlargement side is positive, and the sign of the curvature radius of a surface that is convex to the reduction side is negative. In the fields of the surface number of the surface corresponding to the aperture stop St, the surface number and the expression (St) are shown. The table of basic lens data also shows the optical member PP. The value in the bottom field of the column D in the table indicates a spacing between the display surface Sim and the surface closest to the reduction side in the table. The symbol DD [] is used for the variable surface spacing during focusing, and the surface number of the enlargement side of the spacing is given in [] and is shown in the column of the surface spacing.

Table 2 shows the focal length f, the F-number FNo., and the maximum total angle of view 2ω with respect to the d line. [°] in the fields of 2ω indicates that the unit thereof is degree. In addition, Table 2 shows the variable surface spacings at respective projection distances. The projection distance is a distance on the optical axis from the surface of the imaging optical system closest to the enlargement side to the enlargement-side imaging plane.

In the basic lens data, a reference sign * is added to surface numbers of aspherical surfaces, and values of paraxial curvature radius are shown in the fields of the curvature radius of the aspherical surface. In Table 3, the Sn row shows surface numbers of the aspherical surfaces, and the KA and Am rows show numerical values of the aspherical coefficients for each aspherical surface. Here, m of Am represents an integer of 3 or more and varies depending on the surface. For example, in the first surface of Example 1, m=3, 4, 5, . . . , and 17. The “E±n” (n: an integer) in the numerical values of the aspherical coefficients of Table 3 indicates “x10^{±}”. KA and Am are the aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where,
Zd is an aspherical surface depth (a length of a perpendicular from a point on an aspherical surface at a height h to a plane that is perpendicular to the optical axis Z and in contact with the aspherical surface apex),
h is a height (a distance from the optical axis Z to the lens surface),
C is a reciprocal of the paraxial curvature radius,
KA and Am are aspherical coefficients, and
Σ in the aspheric equation represents the total sum regarding m.

In the data of each of the tables, degrees are used as the unit of an angle, and millimeters (mm) are used as the unit of a length. However, appropriate different units may be used because the optical system can be used even in a case where the system is enlarged or reduced in proportion. Further, each of the following tables shows numerical values rounded off to predetermined decimal places.

TABLE 1
Example 1

| Sn | R | D | Nd | νd | Nd + 0.01 × νd | |
|---|---|---|---|---|---|---|
| *1 | 65.6796 | 70.0009 | | | | Reflecting Surface |
| *2 | 41.4750 | −77.3538 | | | | Reflecting Surface |
| *3 | 66.6053 | DD[3] | | | | Reflecting Surface |
| *4 | −15.5588 | 1.9993 | 1.75501 | 51.16 | 2.26661 | |
| *5 | −89.2503 | DD[5] | | | | |
| 6 | −115.7528 | 5.0001 | 1.51633 | 64.14 | 2.15773 | |
| 7 | −24.8872 | 8.3436 | | | | |
| 8 | 31.1547 | 1.3010 | 1.77250 | 49.60 | 2.26850 | |
| 9 | 26.3023 | 0.7435 | | | | |
| 10 | 26.8646 | 3.4510 | 1.67300 | 38.26 | 2.05560 | |
| 11 | 1350.1015 | DD[11] | | | | |
| 12 | 52.6042 | 3.6008 | 1.51633 | 64.14 | 2.15773 | |
| 13 | −31.1064 | 0.5000 | | | | |
| 14 | −37.3511 | 1.0001 | 1.77250 | 49.60 | 2.26850 | |
| 15 | 22.2865 | 0.1009 | | | | |
| 16(St) | ∞ | 6.5612 | | | | |
| 17 | 25.4964 | 8.5439 | 1.49700 | 81.54 | 2.31240 | |
| 18 | −16.1033 | 0.7002 | 1.81600 | 46.62 | 2.28220 | |
| 19 | 147.1306 | 2.5828 | | | | |
| 20 | 32.1359 | 9.3780 | 1.49700 | 81.61 | 2.31310 | |
| 21 | −23.6621 | 1.4009 | 1.87070 | 40.73 | 2.27800 | |
| 22 | −31.7462 | DD[22] | | | | |
| *23 | 41.1784 | 5.6005 | 1.55332 | 71.68 | 2.27012 | |
| *24 | −52.1325 | DD[24] | | | | |
| 25 | ∞ | 30.0900 | 1.51680 | 64.20 | | |
| 26 | ∞ | 12.2900 | | | | |
| 27 | ∞ | 1.0000 | 1.48749 | 70.44 | | |
| 28 | ∞ | 0.1907 | | | | |

TABLE 2
Example 1

| | Reference | Short Range | Long Range |
|---|---|---|---|
| f | 2.53 | — | — |
| FNo. | 2.10 | — | — |
| 2ω[°] | 154.8 | — | — |
| Projection | 388 | 294 | 600 |
| Distance | | | |
| DD[3] | 91.0538 | 92.3575 | 89.3835 |
| DD[5] | 8.1100 | 8.5400 | 7.6900 |
| DD[11] | 9.0600 | 7.3300 | 11.1500 |
| DD[22] | 0.8800 | 1.3900 | 0.3000 |
| DD[24] | 1.5100 | 1.0000 | 2.0900 |

TABLE 3
Example 1

| Sn | 1 | 2 | 3 |
|---|---|---|---|
| KA | 8.3594692E−01 | −3.1253012E+00 | 5.6138627E−01 |
| A3 | 0.0000000E+00 | −1.5772365E−04 | 2.0540358E−06 |
| A4 | 7.5452686E−07 | −1.7872384E−05 | −7.9436712E−07 |
| A5 | −6.3390312E−09 | 5.0253620E−07 | 2.1918304E−08 |
| A6 | −1.8493291E−09 | 8.5694183E−08 | 1.1808804E−10 |
| A7 | 4.3870052E−11 | −3.8188092E−09 | −2.2968765E−11 |
| A8 | 1.0395522E−12 | −1.9254562E−10 | 4.8987113E−13 |
| A9 | −3.4375367E−14 | 1.2363013E−11 | 5.4781532E−16 |
| A10 | −2.5992409E−16 | 1.0950163E−13 | −1.6796022E−16 |
| A11 | 1.2259030E−17 | −1.6218039E−14 | 1.9250891E−18 |
| A12 | 2.8509591E−20 | 9.3166972E−17 | 1.3261669E−20 |
| A13 | −2.3126401E−21 | 9.2460606E−18 | −3.7806041E−22 |
| A14 | −7.5191346E−25 | −1.1589007E−19 | 9.9821826E−25 |
| A15 | 2.2487010E−25 | −1.9257602E−21 | 2.1112109E−26 |
| A16 | −4.7196667E−29 | 3.1468780E−23 | −1.2523371E−28 |
| A17 | −8.8714246E−30 | | |

| Sn | 4 | 5 | 23 | 24 |
|---|---|---|---|---|
| KA | 1.0000000E+00 | 1.0000000E+00 | 1.0000000E+00 | 1.0000000E+00 |
| A3 | 2.0385460E−18 | 0.0000000E+00 | 4.8289037E−20 | 0.0000000E+00 |
| A4 | 1.7477542E−04 | 1.7666925E−04 | −1.6521910E−05 | −6.1522288E−06 |
| A5 | 5.2037691E−05 | 1.6474011E−05 | 6.6194775E−07 | 1.8214006E−06 |
| A6 | −9.2906097E−06 | −1.6276405E−06 | −1.2836113E−07 | −2.8360100E−07 |
| A7 | 4.0450410E−07 | −3.0533417E−07 | −1.8399175E−09 | 9.5481293E−09 |
| A8 | 5.0493510E−09 | 1.7020431E−08 | 1.6854923E−09 | 1.3810049E−09 |
| A9 | −8.4297716E−11 | 2.5304705E−09 | −9.8253533E−11 | −1.0300268E−10 |
| A10 | 1.2610292E−11 | −1.4868478E−10 | −4.0884170E−12 | −1.7225698E−12 |
| A11 | −6.6588923E−12 | −6.3558540E−12 | 4.0772984E−13 | 1.9768424E−13 |
| A12 | 2.9023055E−13 | 4.1367146E−13 | −4.7688493E−15 | 1.2982708E−15 |

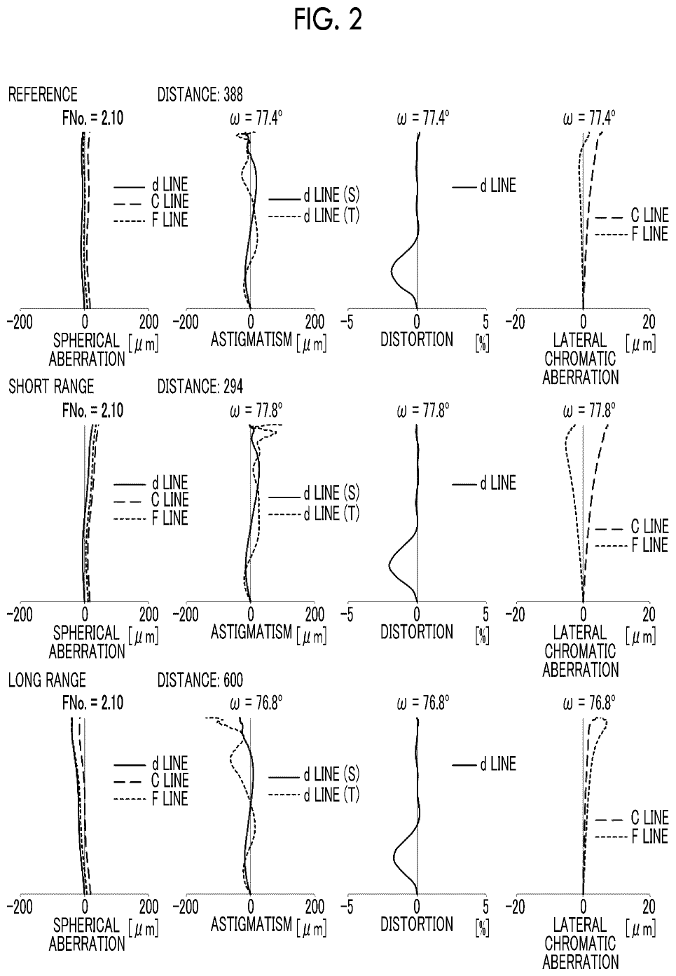

FIG. 2 shows each of aberration diagrams in the imaging optical system according to Example 1 at each of the projection distances. FIG. 2 shows, in order from the left, spherical aberration, astigmatism, distortion, and lateral chromatic aberration. In FIG. 2, regarding each of the projection distances, the upper stage shows each of aberration diagrams for reference, the middle stage shows each of aberration diagrams for a short range, and the lower stage shows each of aberration diagrams for a long range. The distances for “reference”, “short range”, and “long range” of the aberration diagrams are the same as the values of the projection distances shown in the table at the variable surface spacings, respectively. In the spherical aberration diagram, aberrations regarding the d line, the C line, and the F line are indicated by a solid line, a long broken line, and a short broken line, respectively. In the astigmatism diagram, an aberration regarding the d line in the sagittal direction is indicated by a solid line, and an aberration regarding the d line in the tangential direction is indicated by a short broken line. In the distortion diagram, an aberration regarding the d line is indicated by a solid line. In the lateral chromatic aberration diagram, aberrations regarding the C line and the F line are indicated by a long broken line and a short broken line, respectively. In the spherical aberration diagram, a value of the F-number is shown after “FNo.=”. In other aberration diagrams, the value of the maximum half angle of view is shown after “ω=”.

Symbols, meanings, description methods, and illustration methods of the respective data pieces according to Example 1 are basically similar to those in the following examples unless otherwise specified. Therefore, hereinafter, repeated description will not be given.

### Example 2

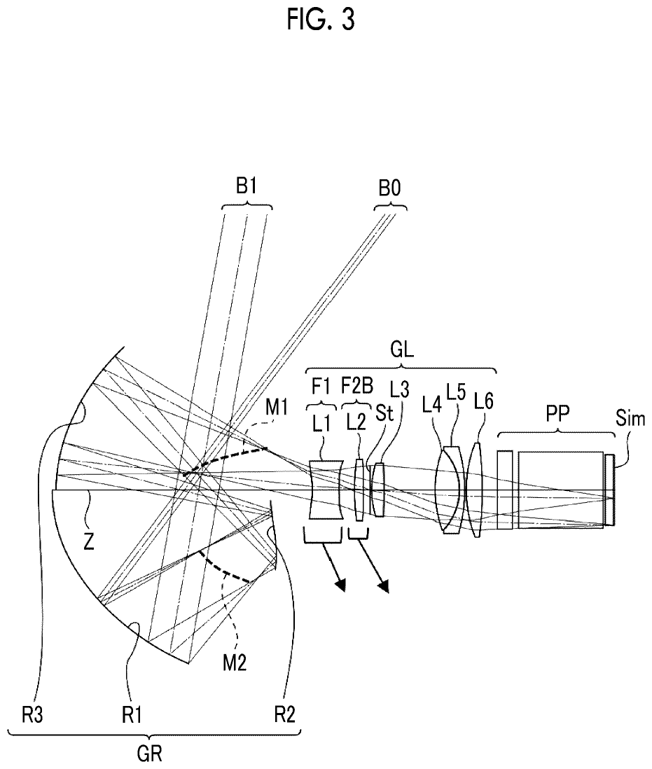

FIG. 3 shows a cross-sectional view of a configuration and luminous flux of an imaging optical system according to Example 2. The imaging optical system according to Example 2 consists of a reflective optical system GR and a refractive optical system GL along the optical path in order from the enlargement side to the reduction side. The reflective optical system GR consists of a first reflecting surface R1 having a positive power, a second reflecting surface R2 having a negative power, and a third reflecting surface R3 having a positive power along the optical path in order from the enlargement side to the reduction side. The refractive optical system GL consists of lenses L1 and L2, an aperture stop St, and lenses L3 to L6 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

The imaging optical system according to Example 2 includes two focusing groups, that is, a F1 focusing group F1 consisting of a lens L1 and a F2B focusing group F2B consisting of a lens L2. During focusing from a long range to a short range, the F1 focusing group F1 moves to the reduction side, the F2B focusing group F2B moves to the reduction side, and the other lenses and reflecting surfaces and the aperture stop St are fixed to the display surface Sim.

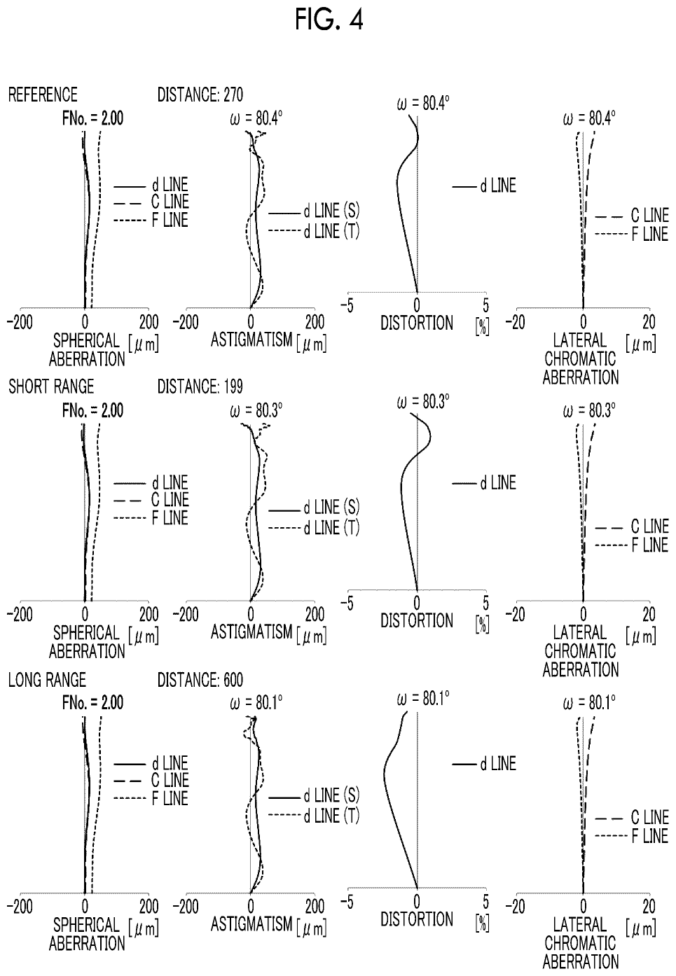

Regarding the imaging optical system according to Example 2, Table 4 shows basic lens data, Table 5 shows specifications and variable surface spacings, Table 6 shows aspherical coefficients, and FIG. 4 shows each of the aberration diagrams.

TABLE 4
Example 2

| Sn | R | D | Nd | νd | Nd + 0.01 × νd | |
|---|---|---|---|---|---|---|
| *1 | 18.9302 | 28.9062 | | | | Reflecting Surface |
| *2 | 26.3339 | −28.3745 | | | | Reflecting Surface |
| *3 | 22.9054 | DD[3] | | | | Reflecting Surface |
| *4 | −9.7297 | 3.4546 | 1.50864 | 56.51 | 2.07374 | |
| *5 | 74.4965 | DD[5] | | | | |
| *6 | 25.8403 | 1.1811 | 1.58313 | 59.46 | 2.17773 | |
| *7 | −553.4580 | DD[7] | | | | |
| 8(St) | ∞ | 0.2006 | | | | |
| 9 | 13.0403 | 1.6126 | 1.59410 | 60.47 | 2.19880 | |
| 10 | −108.1012 | 6.7797 | | | | |
| 11 | 16.6517 | 3.2315 | 1.49700 | 81.61 | 2.31310 | |
| 12 | −8.2752 | 0.7006 | 1.84666 | 23.78 | 2.08446 | |
| 13 | −22.0476 | 0.2004 | | | | |
| 14 | 18.6473 | 2.1196 | 1.70154 | 41.15 | 2.11304 | |
| 15 | −54.2697 | 2.0005 | | | | |
| 16 | ∞ | 2.0000 | 1.51680 | 64.20 | | |
| 17 | ∞ | 0.8000 | | | | |
| 18 | ∞ | 11.2000 | 1.72342 | 37.95 | | |
| 19 | ∞ | 0.3000 | | | | |
| 20 | ∞ | 1.1000 | 1.48749 | 70.44 | | |
| 21 | ∞ | 0.0631 | | | | |

TABLE 5
Example 2

| | Reference | Short Range | Long Range |
|---|---|---|---|
| f | 0.85 | — | — |
| FNo. | 2.00 | — | — |
| 2ω[°] | 160.8 | — | — |
| Projection | 270 | 199 | 600 |
| Distance | | | |
| DD[3] | 33.9618 | 34.2380 | 33.5515 |
| DD[6] | 2.0300 | 2.1700 | 1.8200 |
| DD[8] | 0.9200 | 0.5000 | 1.5400 |

TABLE 6
Example 2

| Sn | 1 | 2 | 3 |
|---|---|---|---|
| KA | 2.7538127E−01 | 4.9521716E+00 | 2.4233249E−02 |
| A3 | −6.5623938E−04 | 4.4026829E−03 | −4.9604049E−06 |
| A4 | 4.4277875E−05 | −2.6928078E−03 | 3.4089655E−05 |
| A5 | 1.7076133E−06 | 6.4819981E−04 | −1.1956148E−05 |
| A6 | 4.4094912E−07 | −5.9708017E−05 | 1.6596578E−06 |
| A7 | −7.4724267E−08 | −6.6356654E−06 | −6.4404866E−08 |
| A8 | −7.0602890E−10 | 1.8903336E−06 | −7.0319048E−09 |
| A9 | 3.9230828E−10 | −7.9933618E−08 | 7.2695205E−10 |
| A10 | −5.8437255E−12 | −1.5112540E−08 | −1.5310984E−12 |
| A11 | −8.3358735E−13 | 1.6465026E−09 | −2.1298739E−12 |
| A12 | 2.0823171E−14 | 1.7127239E−11 | 5.3460885E−14 |
| A13 | 8.0815457E−16 | −9.3551077E−12 | 2.5663541E−15 |
| A14 | −2.5081229E−17 | 2.6607594E−13 | −9.7961677E−17 |
| A15 | −2.9497489E−19 | 1.7685158E−14 | −1.0786362E−18 |
| A16 | 1.0554941E−20 | −8.4105139E−16 | 5.4780065E−20 |

| Sn | 4 | 5 | 6 | 7 |
|---|---|---|---|---|
| KA | 1.0000000E+00 | 1.0000000E+00 | 1.0000000E+00 | 1.0000000E+00 |
| A3 | 0.0000000E+00 | 1.1524242E−17 | 0.0000000E+00 | 0.0000000E+00 |
| A4 | 1.8617781E−03 | 1.2832732E−03 | −1.8545732E−04 | −2.4651584E−04 |
| A5 | 8.4242322E−04 | 7.7809269E−04 | 0.0000000E+00 | 0.0000000E+00 |
| A6 | −1.8308855E−04 | −3.1393198E−04 | 0.0000000E+00 | 0.0000000E+00 |
| A7 | −8.6689933E−05 | 3.1891952E−05 | 0.0000000E+00 | 0.0000000E+00 |
| A8 | 2.4455966E−05 | 2.4168970E−06 | 0.0000000E+00 | 0.0000000E+00 |
| A9 | 2.0225830E−06 | −3.3147494E−07 | 0.0000000E+00 | 0.0000000E+00 |
| A10 | −7.7927358E−07 | −4.5737792E−09 | 0.0000000E+00 | 0.0000000E+00 |
| A11 | | | 0.0000000E+00 | 0.0000000E+00 |
| A12 | | | 0.0000000E+00 | 0.0000000E+00 |
| A13 | | | 0.0000000E+00 | 0.0000000E+00 |
| A14 | | | 0.0000000E+00 | 0.0000000E+00 |
| A15 | | | 0.0000000E+00 | 0.0000000E+00 |
| A16 | | | 0.0000000E+00 | 0.0000000E+00 |
| A17 | | | 0.0000000E+00 | 0.0000000E+00 |
| A18 | | | 0.0000000E+00 | 0.0000000E+00 |
| A19 | | | 0.0000000E+00 | 0.0000000E+00 |
| A20 | | | 0.0000000E+00 | 0.0000000E+00 |

### Example 3

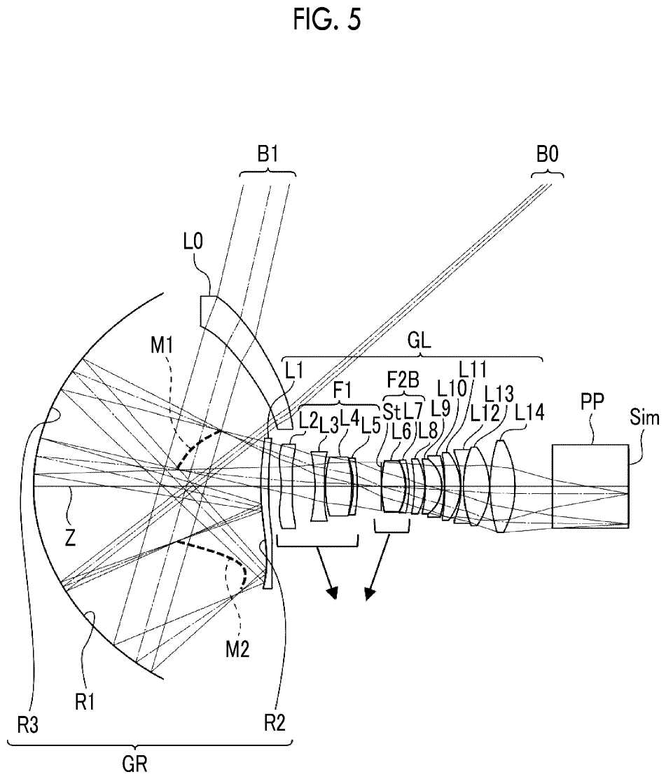

FIG. 5 shows a cross-sectional view of a configuration and luminous flux of an imaging optical system according to Example 3. The imaging optical system according to Example 3 consists of a lens L0, a reflective optical system GR, and a refractive optical system GL along the optical path in order from the enlargement side to the reduction side. The reflective optical system GR consists of a first reflecting surface R1 having a positive power, a second reflecting surface R2 having a negative power, and a third reflecting surface R3 having a positive power along the optical path in order from the enlargement side to the reduction side. The first reflecting surface R1 and the third reflecting surface R3 are formed of the same member and have the same surface shape. A second reflecting surface R2 is formed on a surface of the lens L1 on the reflective optical system side (the left side in FIG. 5). The refractive optical system GL consists of lenses L1 to L5, an aperture stop St, and lenses L6 to L14 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

The imaging optical system according to Example 3 includes two focusing groups, that is, a F1 focusing group F1 consisting of lenses L2 to L5, an aperture stop St, and a F2B focusing group F2B consisting of lenses L6 and L7. During focusing from a long range to a short range, the F1 focusing group F1 moves to the reduction side, the F2B focusing group F2B moves to the enlargement side, and the other lenses and reflecting surfaces are fixed to the display surface Sim.

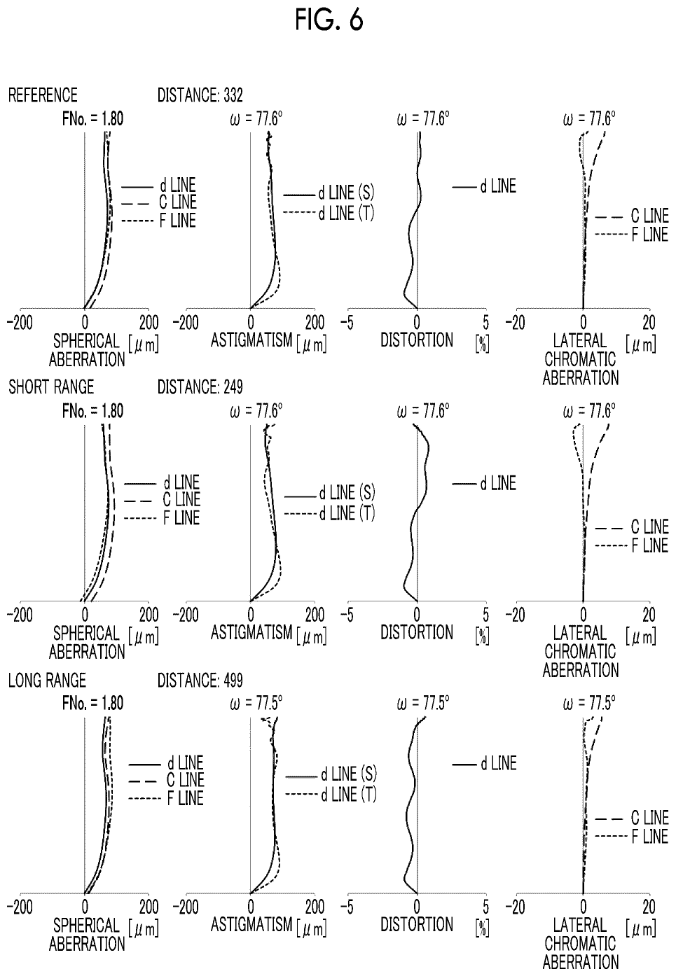

Regarding the imaging optical system according to Example 3, Table 7 shows basic lens data, Table 8 shows specifications and variable surface spacings, Tables 9A and 9B shows aspherical coefficients, and FIG. 6 shows each of the aberration diagrams. The aspherical coefficients are shown to be divided into two tables in order to avoid an increase in the length of one table.

TABLE 7
Example 3

| Sn | R | D | Nd | νd | Nd + 0.01 × νd | |
|---|---|---|---|---|---|---|
| *1 | −167.8007 | −3.7994 | 1.53158 | 55.08 | 2.08238 | |
| *2 | −72.7921 | −80.8600 | | | | |
| *3 | 60.4952 | −73.2463 | | | | Reflecting Surface |
| *4 | 86.8744 | −73.2463 | | | | Reflecting Surface |
| *5 | 60.4952 | 73.2463 | | | | Reflecting Surface |
| *6 | 86.8744 | 2.5001 | 1.53158 | 55.08 | 2.08238 | |
| *7 | 182.9816 | DD[7] | | | | |
| *8 | −20.9199 | 3.5695 | 1.51007 | 56.24 | 2.07247 | |
| *9 | −68.5350 | 7.3064 | | | | |
| *10 | −28.6512 | 2.9994 | 1.51007 | 56.24 | 2.07247 | |
| *11 | −268.1079 | 0.3283 | | | | |
| 12 | 36.9831 | 8.2349 | 1.78880 | 28.43 | 2.07310 | |
| 13 | −41.8916 | 0.5213 | | | | |
| 14 | −31.1474 | 1.3450 | 1.89286 | 20.36 | 2.09646 | |
| 15 | −55.9677 | DD[15] | | | | |
| 16(St) | ∞ | 0.2009 | | | | |
| 17 | 43.1521 | 7.5581 | 1.51742 | 52.43 | 2.04172 | |
| 18 | −18.1925 | 0.2007 | | | | |
| 19 | −17.9653 | 1.0127 | 1.91082 | 35.25 | 2.26332 | |
| 20 | −35.4844 | DD[20] | | | | |
| *21 | −49.7277 | 3.3266 | 1.51633 | 64.06 | 2.15693 | |
| *22 | −19.2261 | 0.2007 | | | | |
| 23 | −39.3352 | 5.3260 | 1.48749 | 70.44 | 2.19189 | |
| 24 | −11.4811 | 0.7990 | 1.90043 | 37.37 | 2.27413 | |
| 25 | −40.0479 | 0.2009 | | | | |
| 26 | −66.4769 | 4.9589 | 1.75520 | 27.51 | 2.03030 | |
| 27 | −18.4869 | 0.2004 | | | | |
| 28 | −31.1870 | 0.7996 | 1.90043 | 37.37 | 2.27413 | |
| 29 | 35.4695 | 8.3969 | 1.49700 | 81.61 | 2.31310 | |
| 30 | −22.9128 | 0.1995 | | | | |
| 31 | 52.5843 | 8.0508 | 1.48749 | 70.44 | 2.19189 | |
| 32 | −33.2405 | 12.0000 | | | | |
| 33 | ∞ | 24.5000 | 1.51680 | 64.20 | | |
| 34 | ∞ | 0.1963 | | | | |

TABLE 8
Example 3

| | Reference | Short Range | Long Range |
|---|---|---|---|
| f | 2.78 | — | — |
| FNo. | 1.80 | — | — |
| 2ω[°] | 155.2 | — | — |
| Projection | 332 | 249 | 499 |
| Distance | | | |
| DD[7] | 4.1400 | 5.2200 | 3.0000 |
| DD[15] | 7.6900 | 5.5800 | 9.9100 |
| DD[20] | 1.7000 | 2.7300 | 0.6200 |

TABLE 9A
Example 3

| Sn | 1 | 2 | 3 | 4 |
|---|---|---|---|---|
| KA | 3.2097927E+00 | 1.7316047E+00 | −7.6993396E−02 | 3.7455750E−01 |
| A3 | 0.0000000E+00 | 0.0000000E+00 | −6.1752283E−07 | 3.5216333E−04 |
| A4 | 6.5791410E−06 | 3.0756713E−05 | 7.4951851E−07 | −8.7571464E−05 |
| A5 | −3.6805551E−07 | −2.6885492E−06 | −5.4808891E−08 | 8.0408307E−06 |
| A6 | −8.1905267E−10 | 8.8612383E−08 | 2.4183131E−09 | −1.7339166E−07 |
| A7 | 1.5226405E−10 | −1.6748069E−09 | −3.9052708E−11 | −2.2891357E−08 |
| A8 | 3.2961776E−12 | 2.7948586E−11 | −3.5369229E−13 | 1.2671764E−09 |
| A9 | −1.1272180E−13 | −1.8573632E−13 | 2.2654631E−14 | 2.3017848E−11 |
| A10 | −5.9994713E−16 | −8.6708445E−15 | −3.2177541E−16 | −2.7761835E−12 |
| A11 | 3.0482310E−17 | 1.6196110E−16 | 1.1221188E−18 | 5.7848398E−15 |
| A12 | −3.1252004E−20 | 9.3825782E−19 | 9.3146800E−20 | 3.2579022E−15 |
| A13 | −3.2859510E−21 | −3.7038714E−20 | −2.7849482E−21 | −3.7057207E−17 |
| A14 | 1.7791813E−23 | 2.0254206E−22 | 5.9501810E−24 | −2.1666026E−18 |
| A15 | | | 7.1531227E−25 | 3.6743692E−20 |
| A16 | | | −5.6254375E−27 | 7.5558747E−22 |
| A17 | | | −7.8559034E−29 | −1.5906827E−23 |
| A18 | | | 8.3727832E−31 | −1.0086195E−25 |
| A19 | | | 3.3482985E−33 | 2.6211558E−27 |
| A20 | | | −4.1921981E−35 | −2.8942541E−30 |

| Sn | 5 | 6 | 7 |
|---|---|---|---|
| KA | −7.6993396E−02 | 3.7455750E−01 | −1.0000000E+01 |
| A3 | −6.1752283E−07 | 3.5216333E−04 | 6.4051851E−04 |
| A4 | 7.4951851E−07 | −8.7571464E−05 | −1.5441734E−04 |
| A5 | −5.4808891E−08 | 8.0408307E−06 | 1.3255296E−05 |
| A6 | 2.4183131E−09 | −1.7339166E−07 | 4.5014394E−07 |
| A7 | −3.9052708E−11 | −2.2891357E−08 | −1.2396899E−07 |
| A8 | −3.5369229E−13 | 1.2671764E−09 | 2.3154328E−09 |
| A9 | 2.2654631E−14 | 2.3017848E−11 | 4.6525137E−10 |
| A10 | −3.2177541E−16 | −2.7761835E−12 | −1.6510581E−11 |
| A11 | 1.1221188E−18 | 5.7848398E−15 | −9.8287412E−13 |
| A12 | 9.3146800E−20 | 3.2579022E−15 | 4.3094245E−14 |
| A13 | −2.7849482E−21 | −3.7057207E−17 | 1.2296164E−15 |
| A14 | 5.9501810E−24 | −2.1666026E−18 | −5.9806755E−17 |
| A15 | 7.1531227E−25 | 3.6743692E−20 | −9.0081118E−19 |
| A16 | −5.6254375E−27 | 7.5558747E−22 | 4.6533834E−20 |
| A17 | −7.8559034E−29 | −1.5906827E−23 | 3.5721624E−22 |
| A18 | 8.3727832E−31 | −1.0086195E−25 | −1.9172097E−23 |
| A19 | 3.3482985E−33 | 2.6211558E−27 | −5.9312320E−26 |
| A20 | −4.1921981E−35 | −2.8942541E−30 | 3.2624731E−27 |

TABLE 9B
Example 3

| Sn | 8 | 9 | 10 | 11 |
|---|---|---|---|---|
| KA | 9.8059546E−01 | 4.0558230E+00 | 1.1172527E+00 | 1.0000009E+01 |
| A3 | 0.0000000E+00 | 0.0000000E+00 | 0.0000000E+00 | 0.0000000E+00 |
| A4 | 4.9050377E−04 | 3.5343909E−04 | 2.1588244E−04 | 1.6274508E−04 |
| A5 | −2.9747330E−05 | −1.4292622E−05 | −1.0060807E−05 | −1.5653913E−06 |
| A6 | −2.9957187E−06 | −2.6095557E−06 | −8.9308120E−07 | −1.3038828E−06 |
| A7 | 5.4123241E−07 | 5.0844624E−08 | −1.2858212E−07 | −1.7915805E−07 |
| A8 | −2.7822263E−08 | 1.3746746E−08 | 2.5713836E−08 | 4.7844644E−08 |
| A9 | −3.8995800E−10 | 2.4342823E−09 | 3.3417854E−09 | 1.5500028E−09 |
| A10 | 1.9402695E−10 | −2.1654600E−10 | −5.6695627E−10 | −7.7884301E−10 |
| A11 | −1.4865922E−11 | −2.8254692E−11 | −2.6102509E−11 | 2.7504347E−12 |
| A12 | −1.3757694E−13 | 2.1279162E−12 | 5.2893164E−12 | 6.1845077E−12 |
| A13 | 7.0924233E−14 | 1.2702126E−13 | 8.8234181E−14 | −6.8320778E−14 |
| A14 | −1.5957878E−15 | −9.5100566E−15 | −2.2773122E−14 | −2.5771680E−14 |
| A15 | −1.2217496E−16 | −2.1398467E−16 | −1.1445573E−16 | 1.8767275E−16 |
| A16 | 4.4492589E−18 | 1.6022130E−17 | 3.8042605E−17 | 4.7385590E−17 |

| Sn | 21 | 22 |
|---|---|---|
| KA | 1.0000000E+00 | 1.0000000E+00 |
| A3 | 0.0000000E+00 | 0.0000000E+00 |
| A4 | −2.0063646E−05 | 1.1062817E−05 |
| A5 | 3.2884015E−07 | −3.2483374E−06 |
| A6 | −1.8243850E−08 | 1.1789506E−06 |
| A7 | −1.6531765E−08 | −1.7337042E−07 |
| A8 | 5.3935471E−09 | 8.2491296E−09 |
| A9 | −5.7180896E−10 | 3.5548861E−10 |
| A10 | 9.4456958E−12 | −4.5429898E−11 |

### Example 4

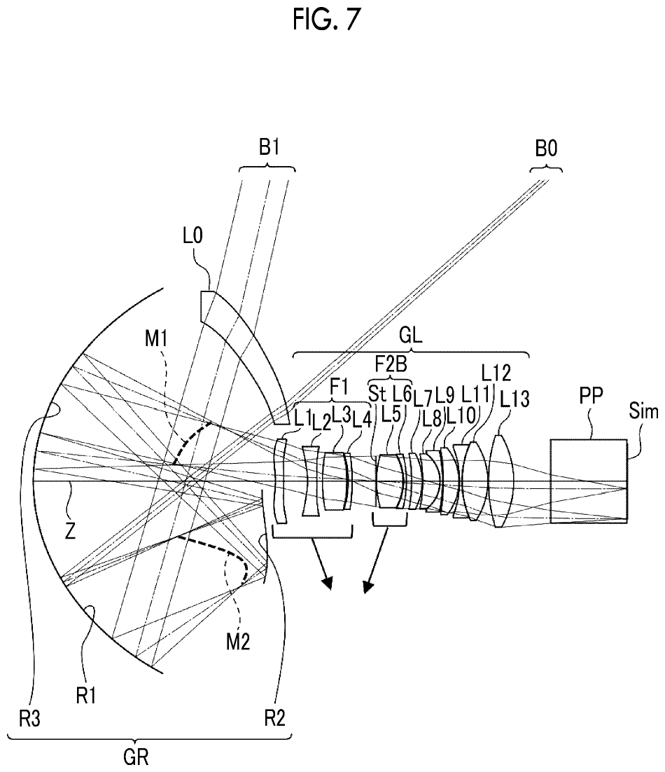

FIG. 7 shows a cross-sectional view of a configuration and luminous flux of an imaging optical system according to Example 4. The imaging optical system according to Example 4 consists of a lens L0, a reflective optical system GR, and a refractive optical system GL along the optical path in order from the enlargement side to the reduction side. The reflective optical system GR consists of a first reflecting surface R1 having a positive power, a second reflecting surface R2 having a negative power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L4, an aperture stop St, and lenses L5 to L13 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

The imaging optical system according to Example 4 includes two focusing groups, that is, a F1 focusing group F1 consisting of lenses L1 to L4, an aperture stop St, and a F2B focusing group F2B consisting of lenses L5 and L6. During focusing from a long range to a short range, the F1 focusing group F1 moves to the reduction side, the F2B focusing group F2B moves to the enlargement side, and the other lenses and reflecting surfaces are fixed to the display surface Sim.

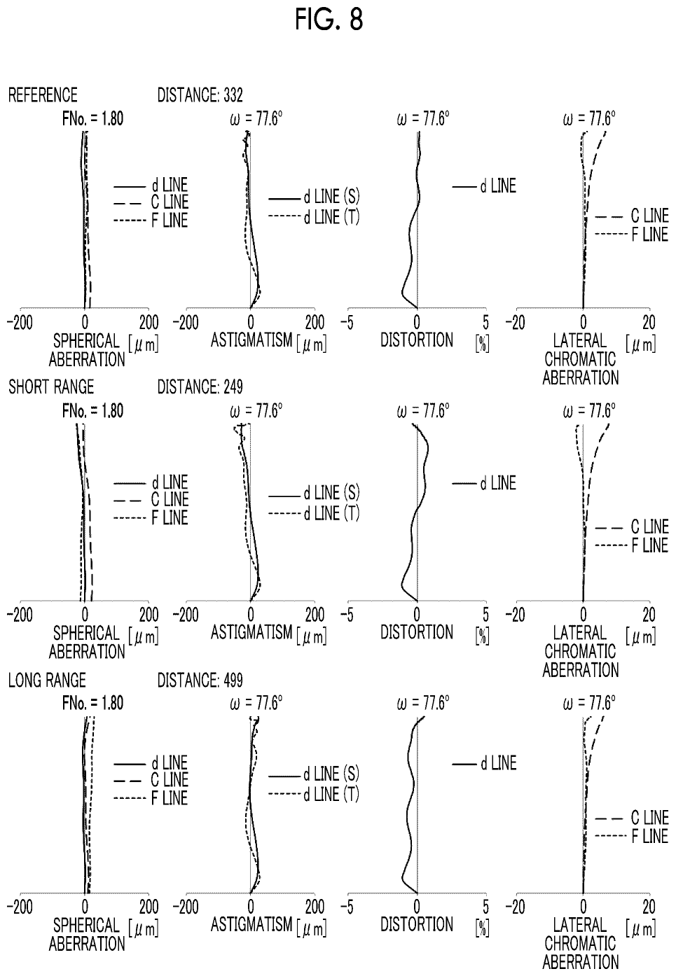

Regarding the imaging optical system according to Example 4, Table 10 shows basic lens data, Table 11 shows specifications and variable surface spacings, Tables 12A and 12B shows aspherical coefficients, and FIG. 8 shows each of the aberration diagrams. The aspherical coefficients are shown to be divided into two tables in order to avoid an increase in the length of one table.

TABLE 10
Example 4

| Sn | R | D | Nd | νd | Nd + 0.01 × νd | |
|---|---|---|---|---|---|---|
| *1 | −154.6601 | −3.8006 | 1.53158 | 55.08 | 2.08238 | |
| *2 | −73.3766 | −80.0037 | | | | |
| *3 | 60.6032 | 73.7352 | | | | Reflecting Surface |
| *4 | 84.2481 | −73.7352 | | | | Reflecting Surface |
| *5 | 60.6032 | DD[5] | | | | Reflecting Surface |
| *6 | −24.7427 | 2.6901 | 1.51007 | 56.24 | 2.07247 | |
| *7 | −52.2839 | 7.6751 | | | | |
| *8 | −22.7082 | 3.0001 | 1.51007 | 56.24 | 2.07247 | |
| *9 | −121.4388 | 1.8173 | | | | |
| 10 | 50.4051 | 7.6866 | 1.85000 | 27.03 | 2.12030 | |
| 11 | −38.7662 | 0.4613 | | | | |
| 12 | −30.6963 | 1.2349 | 1.89286 | 20.36 | 2.09646 | |
| 13 | −64.8373 | DD[13] | | | | |
| 14(St) | ∞ | 0.1989 | | | 0.00000 | |
| 15 | 32.3089 | 8.5474 | 1.51742 | 52.43 | | |
| 16 | −18.4480 | 0.2009 | | | | |
| 17 | −18.0704 | 0.8886 | 1.90043 | 37.37 | 2.27413 | |
| 18 | −37.2824 | DD[18] | | | | |
| *19 | −54.6755 | 3.4163 | 1.51633 | 64.06 | 2.15693 | |
| *20 | −19.3229 | 0.2001 | | | | |
| 21 | −42.9004 | 5.5853 | 1.48749 | 70.44 | 2.19189 | |
| 22 | −11.6418 | 0.7994 | 1.90043 | 37.37 | 2.27413 | |
| 23 | −48.5368 | 0.2007 | | | | |
| 24 | −66.9669 | 5.0787 | 1.74077 | 27.79 | 2.01867 | |
| 25 | −17.9377 | 0.2005 | | | | |
| 26 | −32.0309 | 0.8001 | 1.90043 | 37.37 | 2.27413 | |
| 27 | 32.0828 | 8.2999 | 1.49700 | 81.61 | 2.31310 | |
| 28 | −24.1118 | 0.2008 | | | | |
| 29 | 52.2955 | 8.1505 | 1.48749 | 70.44 | 2.19189 | |
| 30 | −31.6929 | 12.0000 | | | | |
| 31 | ∞ | 24.5000 | 1.51680 | 64.20 | | |
| 32 | ∞ | 0.1960 | | | | |

TABLE 11
Example 4

| | Reference | Short Range | Long Range |
|---|---|---|---|
| f | 2.78 | — | — |
| FNo. | 1.80 | — | — |
| 2ω[°] | 155.2 | — | — |
| Projection | 332 | 249 | 499 |
| Distance | | | |
| DD[5] | 78.1950 | 79.5608 | 76.7532 |
| DD[13] | 7.6700 | 5.3500 | 10.1200 |
| DD[18] | 1.7100 | 2.6600 | 0.7000 |

TABLE 12A
Example 4

| Sn | 1 | 2 |
|---|---|---|
| KA | 3.1923839E+00 | 1.7542382E+00 |
| A3 | 0.0000000E+00 | 0.0000000E+00 |
| A4 | 7.1155038E−06 | 3.0738360E−05 |
| A5 | −3.7469155E−07 | −2.6640382E−06 |
| A6 | −1.1442723E−09 | 8.7703898E−08 |
| A7 | 1.5479962E−10 | −1.6570788E−09 |
| A8 | 3.6585915E−12 | 2.7578556E−11 |
| A9 | −1.1797111E−13 | −1.8287080E−13 |
| A10 | −7.0312809E−16 | −8.5227810E−15 |
| A11 | 3.2456442E−17 | 1.5905827E−16 |
| A12 | −2.2986352E−20 | 9.1529429E−19 |
| A13 | −3.5559226E−21 | −3.6255430E−20 |
| A14 | 1.8814947E−23 | 1.9923567E−22 |

| Sn | 3 | 4 | 5 |
|---|---|---|---|
| KA | −6.4658736E−02 | 3.5426379E−01 | −6.4658736E−02 |
| A3 | 7.4919725E−07 | 3.6549401E−04 | 7.4919725E−07 |
| A4 | 5.7133310E−07 | −9.1490839E−05 | 5.7133310E−07 |
| A5 | −4.5815111E−08 | 8.1733500E−06 | −4.5815111E−08 |
| A6 | 2.2680023E−09 | −1.6555584E−07 | 2.2680023E−09 |
| A7 | −4.3539811E−11 | −2.3477140E−08 | −4.3539811E−11 |
| A8 | −9.8647287E−14 | 1.2724607E−09 | −9.8647287E−14 |
| A9 | 2.0264492E−14 | 2.3795644E−11 | 2.0264492E−14 |
| A10 | −4.4486279E−16 | −2.8136163E−12 | −4.4486279E−16 |
| A11 | 4.2930240E−18 | 5.8337164E−15 | 4.2930240E−18 |
| A12 | 1.1136674E−19 | 3.3084047E−15 | 1.1136674E−19 |
| A13 | −4.0980702E−21 | −3.8207633E−17 | −4.0980702E−21 |
| A14 | 1.0010303E−23 | −2.1921050E−18 | 1.0010303E−23 |
| A15 | 9.8608465E−25 | 3.7965030E−20 | 9.8608465E−25 |
| A16 | −7.5057501E−27 | 7.5384797E−22 | −7.5057501E−27 |
| A17 | −1.0677154E−28 | −1.6449371E−23 | −1.0677154E−28 |
| A18 | 1.0928279E−30 | −9.4733108E−26 | 1.0928279E−30 |
| A19 | 4.5355179E−33 | 2.7119763E−27 | 4.5355179E−33 |
| A20 | −5.4168204E−35 | −4.4761823E−30 | −5.4168204E−35 |

TABLE 12B
Example 4

| Sn | 6 | 7 | 8 | 9 |
|---|---|---|---|---|
| KA | 1.0090726E+00 | 4.6635014E+00 | 1.1330774E+00 | 1.0000009E+01 |
| A3 | 0.0000000E+00 | 0.0000000E+00 | 0.0000000E+00 | 0.0000000E+00 |
| A4 | 3.7599854E−04 | 3.1112423E−04 | 2.3064514E−04 | 1.7075262E−04 |
| A5 | −9.0881475E−06 | −1.3037500E−05 | −6.7898369E−06 | −5.8105467E−07 |
| A6 | −3.4309302E−06 | −9.4371996E−07 | −1.0966920E−06 | −8.4263052E−07 |
| A7 | 1.7437532E−07 | −8.9556127E−08 | −1.2182684E−07 | −2.9521928E−07 |
| A8 | 1.2576826E−08 | −1.4725115E−08 | 2.4335773E−08 | 4.5391169E−08 |
| A9 | 8.6346618E−10 | 7.1122545E−09 | 2.6569810E−09 | 3.6532931E−09 |
| A10 | −1.6759531E−10 | −9.4097147E−11 | −4.8562012E−10 | −8.7587773E−10 |
| A11 | −1.0632652E−11 | −8.0783384E−11 | −1.8648161E−11 | −1.3471424E−11 |
| A12 | 1.2511350E−12 | 2.9728343E−12 | 4.3886595E−12 | 7.6992424E−12 |
| A13 | 3.4543020E−14 | 3.9325198E−13 | 5.4772671E−14 | −1.2447408E−14 |
| A14 | −3.9191835E−15 | −1.8892417E−14 | −1.8756070E−14 | −3.4709615E−14 |
| A15 | −4.5995242E−17 | −7.3455733E−16 | −5.9240248E−17 | 1.2049665E−16 |
| A16 | 4.7758182E−18 | 4.0035603E−17 | 3.1720522E−17 | 6.7879768E−17 |

| Sn | 19 | 20 |
|---|---|---|
| KA | 1.0000000E+00 | 1.0000000E+00 |
| A3 | 0.0000000E+00 | 0.0000000E+00 |
| A4 | −1.7926115E−05 | 1.5982195E−05 |
| A5 | 1.4434045E−06 | −1.3217104E−06 |
| A6 | −1.3482509E−07 | 6.5303003E−07 |
| A7 | −1.1211216E−08 | −9.0214885E−08 |
| A8 | 7.4545010E−09 | 3.8832707E−09 |
| A9 | −8.4305406E−10 | 2.2363662E−10 |
| A10 | 2.8239444E−11 | −2.3001831E−11 |

### Example 5

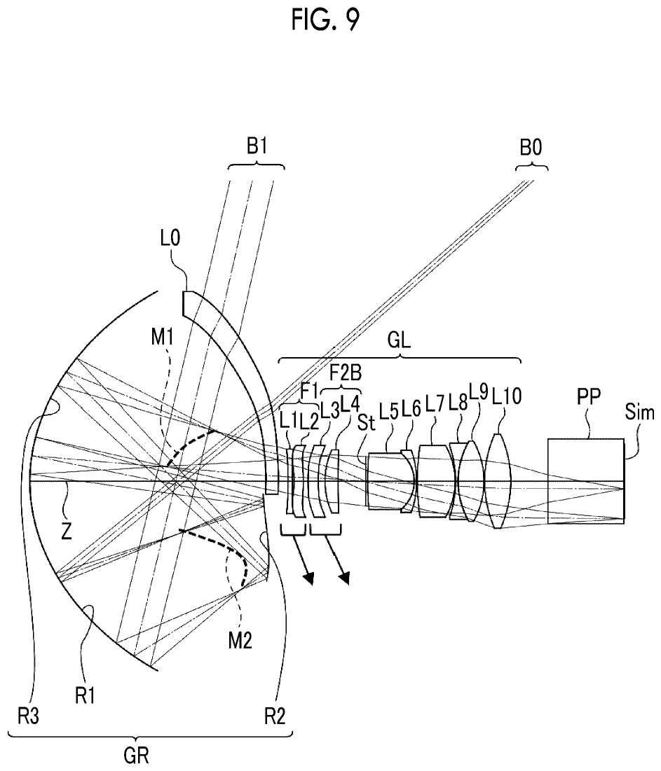

FIG. 9 shows a cross-sectional view of a configuration and luminous flux of an imaging optical system according to Example 5. The imaging optical system according to Example 5 consists of a lens L0, a reflective optical system GR, and a refractive optical system GL along the optical path in order from the enlargement side to the reduction side. The reflective optical system GR consists of a first reflecting surface R1 having a positive power, a second reflecting surface R2 having a negative power, and a third reflecting surface R3 having a positive power along the optical path in order from the enlargement side to the reduction side. The first reflecting surface R1 and the third reflecting surface R3 are formed of the same member and have the same surface shape. A luminous flux from the refractive optical system GL to the enlargement side transmits through the lens L0, is reflected from the third reflecting surface R3, the second reflecting surface R2, and the first reflecting surface R1, transmits through the lens L0 again, and travels to the enlargement-side imaging plane. The refractive optical system GL consists of lenses L1 to L4, an aperture stop St, and lenses L5 to L10 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

The imaging optical system according to Example 5 includes two focusing groups, that is, a F1 focusing group F1 consisting of lenses L1 and L2 and a F2B focusing group F2B consisting of lenses L3 and L4. During focusing from a long range to a short range, the F1 focusing group F1 moves to the reduction side, the F2B focusing group F2B moves to the reduction side, and the other lenses and reflecting surfaces and the aperture stop St are fixed to the display surface Sim.

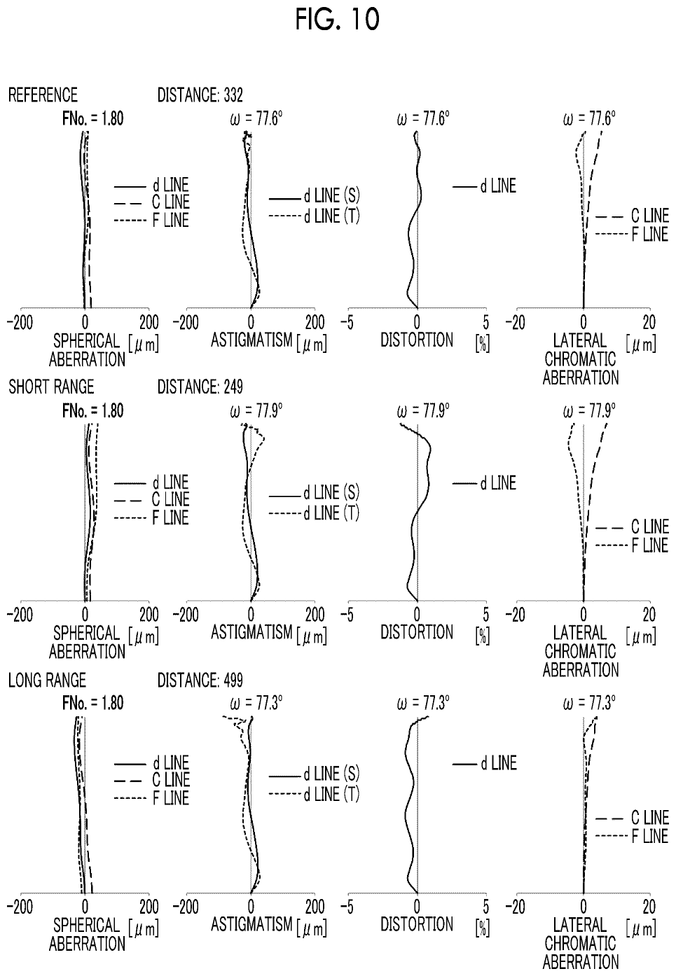

Regarding the imaging optical system according to Example 5, Table 13 shows basic lens data, Table 14 shows specifications and variable surface spacings, Tables 15A and 15B shows aspherical coefficients, and FIG. 10 shows each of the aberration diagrams. The aspherical coefficients are shown to be divided into two tables in order to avoid an increase in the length of one table.

TABLE 13
Example 5

| Sn | R | D | Nd | νd | Nd + 0.01 × νd | |
|---|---|---|---|---|---|---|
| *1 | −129.2636 | −4.0009 | 1.53158 | 55.08 | 2.08238 | |
| *2 | −78.9201 | −76.2124 | | | | |
| *3 | 58.2218 | 75.2116 | | | | Reflecting Surface |
| *4 | 85.2960 | −75.2116 | | | | Reflecting Surface |
| *5 | 58.2218 | 76.2124 | | | | Reflecting Surface |
| *6 | −78.9201 | 4.0009 | 1.53158 | 55.08 | 2.08238 | |
| *7 | −129.2636 | DD[7] | | | | |
| 8 | −117.9381 | 1.3446 | 1.89286 | 20.36 | 2.09646 | |
| 9 | 370.1350 | 0.5531 | | | | |
| *10 | −32.4368 | 3.0009 | 1.51007 | 56.24 | 2.07247 | |
| *11 | −44.7297 | DD[11] | | | | |
| *12 | 144.1718 | 3.3374 | 1.51007 | 56.24 | 2.07247 | |
| *13 | 105.4886 | 2.1415 | | | | |
| 14 | 26.2694 | 4.0327 | 1.69895 | 30.13 | 2.00025 | |
| 15 | 319.4676 | DD[15] | | | | |
| 16(St) | ∞ | 0.5867 | | | | |
| 17 | 115.7627 | 15.0100 | 1.48749 | 70.44 | 2.19189 | |
| 18 | −12.5390 | 0.7998 | 1.90043 | 37.37 | | |
| 19 | −31.4134 | 0.2009 | | | 0.00000 | |
| 20 | 83.3395 | 12.1678 | 1.63980 | 34.47 | | |
| 21 | −25.0647 | 0.2001 | | | 0.00000 | |
| 22 | −37.3316 | 0.8001 | 1.90043 | 37.37 | 2.27413 | |
| 23 | 27.6700 | 8.3695 | 1.49700 | 81.61 | 2.31310 | |
| 24 | −27.9852 | 0.2008 | | | | |
| 25 | 40.2402 | 8.4126 | 1.48749 | 70.44 | 2.19189 | |
| 26 | −39.0412 | 12.0000 | | | | |
| 27 | ∞ | 24.5000 | 1.51680 | 64.20 | | |
| 28 | ∞ | 0.1883 | | | | |

TABLE 14
Example 5

| | Reference | Short Range | Long Range |
|---|---|---|---|
| f | 2.78 | — | — |
| FNo. | 1.80 | — | — |
| 2ω[°] | 155.2 | — | — |
| Projection | 332 | 249 | 499 |
| Distance | | | |
| DD[7] | 3.1700 | 5.4900 | 1.0000 |
| DD[11] | 1.5100 | 0.5800 | 2.4200 |
| DD[15] | 8.9700 | 7.5800 | 10.2300 |

TABLE 15A
Example 5

| Sn | 1 | 2 |
|---|---|---|
| KA | 2.5241522E+00 | 1.8462010E+00 |
| A3 | 0.0000000E+00 | 0.0000000E+00 |
| A4 | 6.9047612E−06 | 2.5530091E−05 |
| A5 | −2.9684846E−07 | −2.1465534E−06 |
| A6 | −2.3003828E−09 | 6.7594108E−08 |
| A7 | 9.9656642E−11 | −1.2268271E−09 |
| A8 | 3.9600240E−12 | 2.0152605E−11 |
| A9 | −7.3026014E−14 | −1.1919312E−13 |
| A10 | −1.0485670E−15 | −6.0592195E−15 |
| A11 | 1.8518497E−17 | 9.4993828E−17 |
| A12 | 1.1214639E−19 | 7.4573212E−19 |
| A13 | −1.8917998E−21 | −1.9765943E−20 |
| A14 | −8.6261438E−26 | 7.7750292E−23 |

| Sn | 3 | 4 | 5 |
|---|---|---|---|
| KA | −6.9213644E−02 | −1.5391279E−02 | −6.9213644E−02 |
| A3 | −9.0774142E−08 | 2.5888716E−04 | −9.0774142E−08 |
| A4 | 6.5993791E−07 | −6.6878925E−05 | 6.5993791E−07 |
| A5 | −6.0520401E−08 | 5.3361488E−06 | −6.0520401E−08 |
| A6 | 3.1389998E−09 | −5.4722298E−08 | 3.1389998E−09 |
| A7 | −5.2069754E−11 | −1.5775807E−08 | −5.2069754E−11 |
| A8 | −1.0951790E−12 | 5.2753731E−10 | −1.0951790E−12 |
| A9 | 4.7587494E−14 | 2.4685326E−11 | 4.7587494E−14 |
| A10 | −5.4690501E−17 | −1.2114982E−12 | −5.4690501E−17 |
| A11 | −1.5396604E−17 | −2.4278061E−14 | −1.5396604E−17 |
| A12 | 8.9928172E−20 | 1.5940773E−15 | 8.9928172E−20 |
| A13 | 2.8730597E−21 | 1.3564083E−17 | 2.8730597E−21 |
| A14 | −1.9012002E−23 | −1.2757222E−18 | −1.9012002E−23 |
| A15 | −3.5891795E−25 | −3.0189460E−21 | −3.5891795E−25 |
| A16 | 1.8013847E−27 | 5.9792842E−22 | 1.8013847E−27 |
| A17 | 2.8856143E−29 | −3.8420593E−25 | 2.8856143E−29 |
| A18 | −6.4560732E−32 | −1.4858286E−25 | −6.4560732E−32 |
| A19 | −1.0725115E−33 | 2.0109743E−28 | −1.0725115E−33 |
| A20 | −8.5595762E−37 | 1.4900180E−29 | −8.5595762E−37 |

TABLE 15B
Example 5

| Sn | 6 | 7 |
|---|---|---|
| KA | 1.8462010E+00 | 2.5241522E+00 |
| A3 | 0.0000000E+00 | 0.0000000E+00 |
| A4 | 2.5530092E−05 | 6.9047609E−06 |
| A5 | −2.1465534E−06 | −2.9684847E−07 |
| A6 | 6.7594112E−08 | −2.3003827E−09 |
| A7 | −1.2268272E−09 | 9.9656647E−11 |
| A8 | 2.0152607E−11 | 3.9600242E−12 |
| A9 | −1.1919313E−13 | −7.3026018E−14 |
| A10 | −6.0592201E−15 | −1.0485670E−15 |
| A11 | 9.4993839E−17 | 1.8518498E−17 |
| A12 | 7.4573222E−19 | 1.1214640E−19 |
| A13 | −1.9765945E−20 | −1.8918000E−21 |
| A14 | 7.7750304E−23 | −8.6261445E−26 |

| Sn | 10 | 11 | 12 | 13 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 1.6180602E−04 | 1.5670506E−04 | 1.6237108E−04 | 1.1768129E−04 |
| A5 | −3.7718675E−06 | −1.0149851E−05 | −7.7243003E−06 | 7.5696572E−06 |
| A6 | −1.7775534E−07 | 2.3806887E−07 | 4.2503088E−07 | −1.9352153E−06 |
| A7 | 3.0048747E−08 | 8.3360172E−08 | 1.1838953E−08 | 1.8590064E−07 |
| A8 | 1.3878181E−09 | −5.2405991E−09 | −4.6019497E−09 | −2.3006460E−09 |
| A9 | −2.1347875E−10 | −1.5951507E−10 | −2.0396514E−11 | −1.1801122E−09 |
| A10 | 6.6026786E−12 | 1.7447578E−11 | 6.4711580E−12 | 5.4876573E−11 |

### Example 6

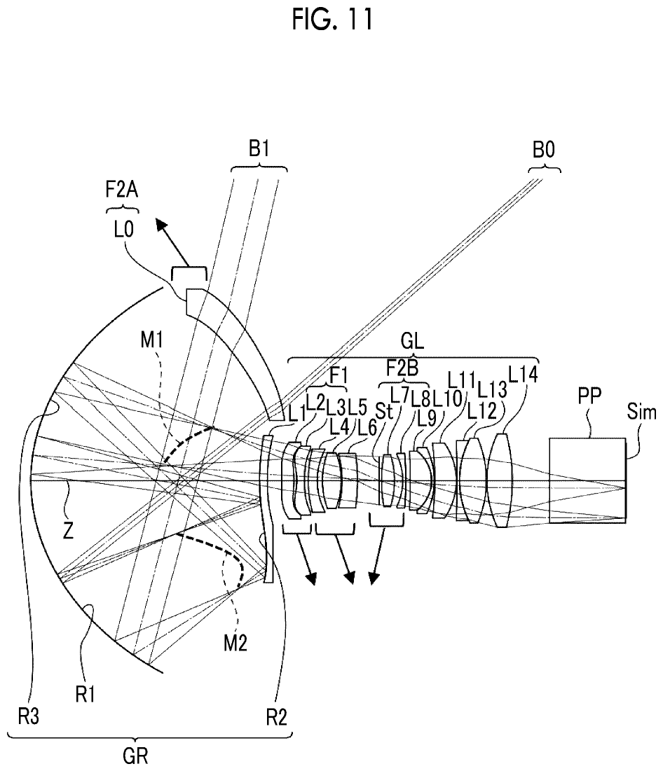

FIG. 11 shows a cross-sectional view of a configuration and luminous flux of an imaging optical system according to Example 6. The imaging optical system according to Example 6 consists of a lens L0, a reflective optical system GR, and a refractive optical system GL along the optical path in order from the enlargement side to the reduction side. The reflective optical system GR consists of a first reflecting surface R1 having a positive power, a second reflecting surface R2 having a negative power, and a third reflecting surface R3 having a positive power along the optical path in order from the enlargement side to the reduction side. The first reflecting surface R1 and the third reflecting surface R3 are formed of the same member and have the same surface shape. A second reflecting surface R2 is formed on a surface of the lens L1 on the reflective optical system side (the left side in FIG. 11). The refractive optical system GL consists of lenses L1 to L6, an aperture stop St, and lenses L7 to L14 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

The imaging optical system according to Example 6 includes four focusing groups, that is, a F2A focusing group F2A consisting of a lens L0, a F1 focusing group F1 consisting of lenses L2 and L3, a focusing group consisting of lenses L4 to L6, an aperture stop St, and a F2B focusing group F2B consisting of lenses L7 and L8. During focusing from a long range to a short range, the F2A focusing group F2A moves to the reduction side, the F1 focusing group F1 moves to the reduction side, the focusing group consisting of the lenses L4 to L6 moves to the reduction side, the F2B focusing group F2B moves to the enlargement side, and the other lenses and reflecting surfaces are fixed to the display surface Sim.

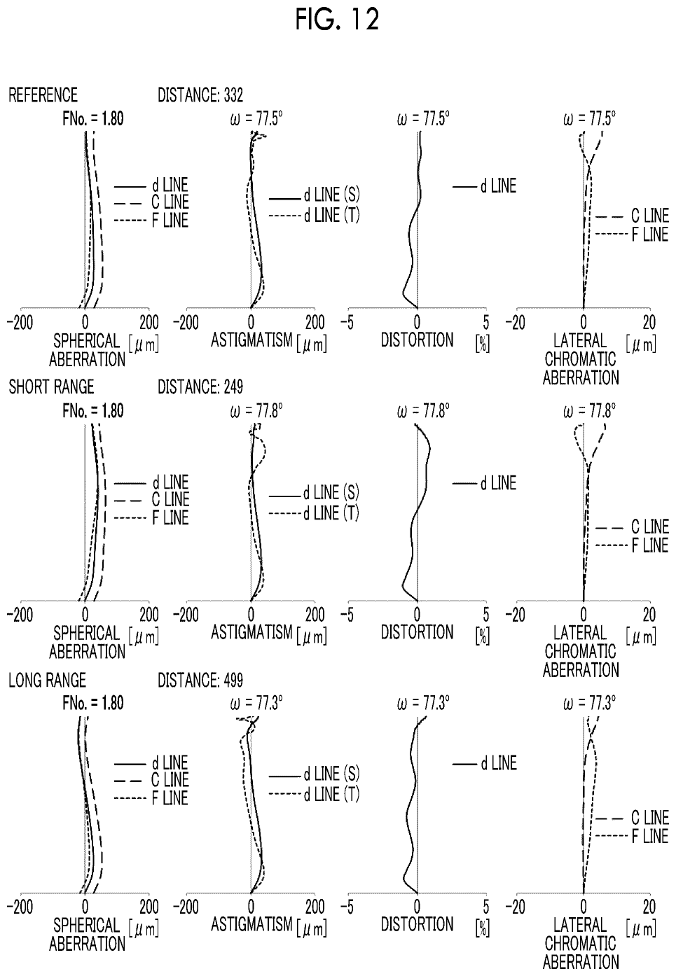

Regarding the imaging optical system according to Example 6, Table 16 shows basic lens data, Table 17 shows specifications and variable surface spacings, Tables 18A and 18B shows aspherical coefficients, and FIG. 12 shows each of the aberration diagrams. The aspherical coefficients are shown to be divided into two tables in order to avoid an increase in the length of one table.

TABLE 16
Example 6

| Sn | R | D | Nd | νd | Nd + 0.01 × νd | |
|---|---|---|---|---|---|---|
| *1 | −153.0846 | −3.8010 | 1.53158 | 55.08 | 2.08238 | |
| *2 | −76.4838 | DD[2] | | | | |
| *3 | 59.0525 | 73.7452 | | | | Reflecting Surface |
| *4 | 73.8335 | −73.7452 | | | | Reflecting Surface |
| *5 | 59.0525 | 73.7452 | | | | Reflecting Surface |
| *6 | 73.8335 | 2.4991 | 1.53158 | 55.08 | 2.08238 | |
| *7 | 80.2318 | DD[7] | | | | |
| *8 | −121.6219 | 3.9217 | 1.88202 | 37.22 | 2.25422 | |
| *9 | −31.4309 | 0.9584 | | | | |
| *10 | −17.1747 | 2.5009 | 1.51007 | 56.24 | 2.07247 | |
| *11 | 94.2848 | DD[11] | | | | |
| *12 | 65.5877 | 2.8904 | 1.51007 | 56.24 | 2.07247 | |
| *13 | 25.3043 | 1.6659 | | | | |
| 14 | 27.4413 | 5.8851 | 1.59551 | 39.24 | 1.98791 | |
| 15 | −25.5845 | 0.2006 | | | | |
| 16 | −38.0304 | 4.9982 | 1.89286 | 20.36 | 2.09646 | |
| 17 | −68.9274 | DD[17] | | | | |
| 18(St) | ∞ | 0.6948 | | | | |
| 19 | 49.3829 | 4.1860 | 1.51742 | 52.43 | 2.04172 | |
| 20 | −30.3078 | 2.6577 | | | | |
| 21 | −20.5928 | 1.0010 | 1.88100 | 40.14 | 2.28240 | |
| 22 | −113.9247 | DD[22] | | | | |
| 23 | −223.2237 | 6.9069 | 1.48749 | 70.44 | 2.19189 | |
| 24 | −12.7225 | 0.8003 | 1.85033 | 42.70 | 2.27733 | |
| 25 | −26.5106 | 0.2009 | | | | |
| 26 | −102.0515 | 6.9750 | 1.59551 | 39.24 | 1.98791 | |
| 27 | −22.2398 | 0.2010 | | | | |
| 28 | −412.3199 | 0.8007 | 1.90043 | 37.37 | 2.27413 | |
| 29 | 30.8006 | 8.6641 | 1.49700 | 81.61 | 2.31310 | |
| 30 | −37.3264 | 0.2008 | | | | |
| 31 | 37.8262 | 8.1610 | 1.48749 | 70.44 | 2.19189 | |
| 32 | −65.1525 | 12.0000 | | | | |
| 33 | ∞ | 24.5000 | 1.51680 | 64.20 | | |
| 34 | ∞ | 0.2048 | | | | |

TABLE 17
Example 6

| | Reference | Short Range | Long Range |
|---|---|---|---|
| f | 2.78 | — | — |
| FNo. | 1.80 | — | — |
| 2ω[°] | 155.0 | — | — |
| Projection | 332 | 249 | 499 |
| Distance | | | |
| DD[2] | −79.2990 | −79.1483 | −79.6864 |
| DD[7] | 4.6400 | 6.1600 | 3.0000 |
| DD[11] | 1.2000 | 0.5000 | 1.9300 |
| DD[17] | 7.0600 | 5.6000 | 9.1600 |
| DD[22] | 1.4100 | 2.3400 | 0.5100 |

TABLE 18A
Example 6

| Sn | 1 | 2 | 3 | 4 |
|---|---|---|---|---|
| KA | 2.9728181E+00 | 1.7937531E+00 | −9.6081995E−02 | 4.2860103E−01 |
| A3 | 0.0000000E+00 | 0.0000000E+00 | 4.2161215E−06 | 2.6710007E−04 |
| A4 | 5.3816698E−06 | 2.5276164E−05 | 1.4750556E−07 | −7.1379976E−05 |
| A5 | −2.8391618E−07 | −2.1244221E−06 | −2.3714203E−08 | 6.4547965E−06 |
| A6 | −8.7397677E−10 | 6.6805483E−08 | 2.1775262E−09 | −1.3797443E−07 |
| A7 | 9.7935490E−11 | −1.2155977E−09 | −6.9938164E−11 | −1.7742604E−08 |
| A8 | 2.7527870E−12 | 1.9994302E−11 | 3.6534017E−13 | 9.2438284E−10 |
| A9 | −6.6807756E−14 | −1.1586814E−13 | 3.5887954E−14 | 2.0555636E−11 |
| A10 | −6.6379481E−16 | −6.0536500E−15 | −8.2564943E−16 | −1.9891072E−12 |
| A11 | 1.6252649E−17 | 9.3594406E−17 | −1.1620723E−18 | −6.8991002E−15 |
| A12 | 5.6116840E−20 | 7.6308518E−19 | 2.7098312E−19 | 2.4240795E−15 |
| A13 | −1.5914286E−21 | −1.9595671E−20 | −2.8929617E−21 | −1.1064786E−17 |
| A14 | 2.1548101E−24 | 7.3947120E−23 | −2.9541792E−23 | −1.7758639E−18 |
| A15 | | | 8.1615604E−25 | 1.4940330E−20 |
| A16 | | | −1.6055792E−27 | 7.5045924E−22 |
| A17 | | | −9.2574784E−29 | −7.1259702E−24 |
| A18 | | | 5.9939529E−31 | −1.6177826E−25 |
| A19 | | | 3.9980612E−33 | 1.2286084E−27 |
| A20 | | | −3.6315408E−35 | 1.2712059E−29 |

| Sn | 5 | 6 | 7 |
|---|---|---|---|
| KA | −9.6081995E−02 | 4.2860103E−01 | −1.0000000E+01 |
| A3 | 4.2161215E−06 | 2.6710012E−04 | 4.5858278E−04 |
| A4 | 1.4750556E−07 | −7.1379976E−05 | −1.1733124E−04 |
| A5 | −2.3714203E−08 | 6.4547964E−06 | 1.4041244E−05 |
| A6 | 2.1775262E−09 | −1.3797443E−07 | 1.7317640E−07 |
| A7 | −6.9938164E−11 | −1.7742604E−08 | −1.1559137E−07 |
| A8 | 3.6534017E−13 | 9.2438281E−10 | 2.2762436E−09 |
| A9 | 3.5887954E−14 | 2.0555636E−11 | 4.5732109E−10 |
| A10 | −8.2564943E−16 | −1.9891072E−12 | −1.3352266E−11 |
| A11 | −1.1620723E−18 | −6.8991005E−15 | −1.0750062E−12 |
| A12 | 2.7098312E−19 | 2.4240794E−15 | 3.2846053E−14 |
| A13 | −2.8929617E−21 | −1.1064785E−17 | 1.5052600E−15 |
| A14 | −2.9541792E−23 | −1.7758639E−18 | 4.3830530E−17 |
| A15 | 8.1615604E−25 | 1.4940329E−20 | −1.2238369E−18 |
| A16 | −1.6055792E−27 | 7.5045922E−22 | 3.2971858E−20 |
| A17 | −9.2574784E−29 | −7.1259700E−24 | 5.3269050E−22 |
| A18 | 5.9939529E−31 | −1.6177825E−25 | −1.3154813E−23 |
| A19 | 3.9980612E−33 | 1.2286084E−27 | −9.6030645E−26 |
| A20 | −3.6315408E−35 | 1.2712058E−29 | 2.1682869E−27 |

TABLE 18B
Example 6

| Sn | 8 | 9 | 10 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 1.5745779E−04 | 2.2777659E−04 | 4.4393423E−04 |
| A5 | 4.0768658E−06 | 1.1696526E−05 | −1.7835491E−06 |
| A6 | −1.5241595E−06 | −2.8627629E−06 | −3.4878502E−06 |
| A7 | 1.0387893E−07 | 1.4417080E−07 | 1.4460682E−07 |
| A8 | −5.2953840E−10 | 1.0056205E−08 | 2.1770782E−08 |
| A9 | −2.2182986E−10 | −3.9873642E−10 | −8.3692431E−10 |
| A10 | 6.5009944E−12 | −1.8668943E−11 | −2.6527366E−11 |
| Sn | 11 | 12 | 13 |
| KA | 1.0000000E+00 | 1.0000000E+00 | 1.0000000E+00 |
| A3 | 0.0000000E+00 | 0.0000000E+00 | 0.0000000E+00 |
| A4 | 2.5319004E−04 | 1.6634254E−04 | 1.0386413E−04 |
| A5 | −6.6662999E−06 | −1.1695288E−05 | −9.8046792E−07 |
| A6 | −1.2649894E−06 | −1.9407848E−07 | −1.9780129E−06 |
| A7 | 2.8941886E−08 | 1.6900953E−08 | 1.7283178E−07 |
| A8 | 3.6305882E−09 | −3.5211424E−10 | −5.0208426E−10 |
| A9 | −5.2545604E−11 | −1.4688780E−11 | −7.7142806E−10 |
| A10 | −3.8497656E−12 | 5.1616122E−13 | 3.5014951E−11 |

### Example 7

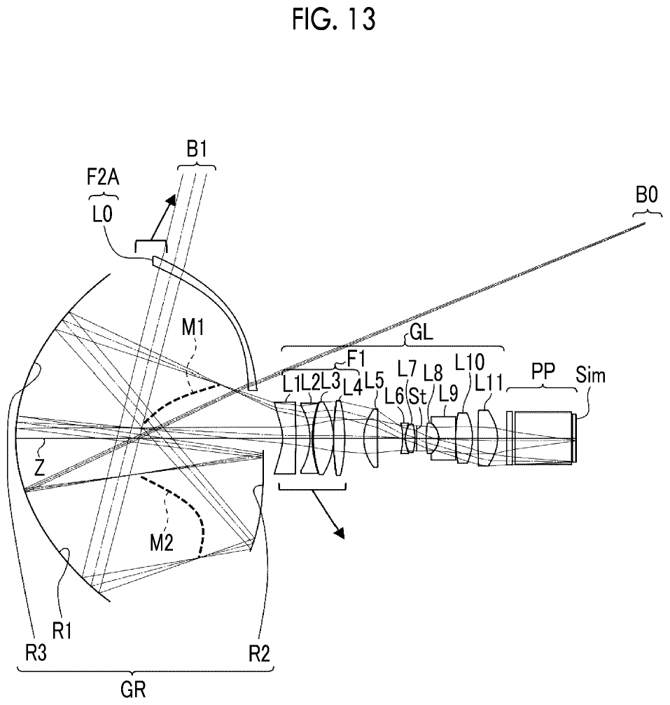

FIG. 13 shows a cross-sectional view of a configuration and luminous flux of an imaging optical system according to Example 7. The imaging optical system according to Example 7 consists of a lens L0, a reflective optical system GR, and a refractive optical system GL along the optical path in order from the enlargement side to the reduction side. The reflective optical system GR consists of a first reflecting surface R1 having a positive power, a second reflecting surface R2 having a negative power, and a third reflecting surface R3 having a positive power along the optical path in order from the enlargement side to the reduction side. The first reflecting surface R1 and the third reflecting surface R3 are formed of the same member and have the same surface shape. The refractive optical system GL consists of lenses L1 to L7, an aperture stop St, and lenses L8 to L11 in order from the enlargement side to the reduction side. A first intermediate image M1 is formed on the optical path between the refractive optical system GL and the third reflecting surface R3. A second intermediate image M2 is formed on the optical path between the second reflecting surface R2 and the first reflecting surface R1.

The imaging optical system according to Example 7 includes two focusing groups, that is, a F2A focusing group F2A consisting of a lens L0 and a F1 focusing group F1 consisting of lenses L1 to L4. During focusing from a long range to a short range, the F2A focusing group F2A moves to the enlargement side, the F1 focusing group F1 moves to the reduction side, and the other lenses and reflecting surfaces and the aperture stop St are fixed to the display surface Sim.

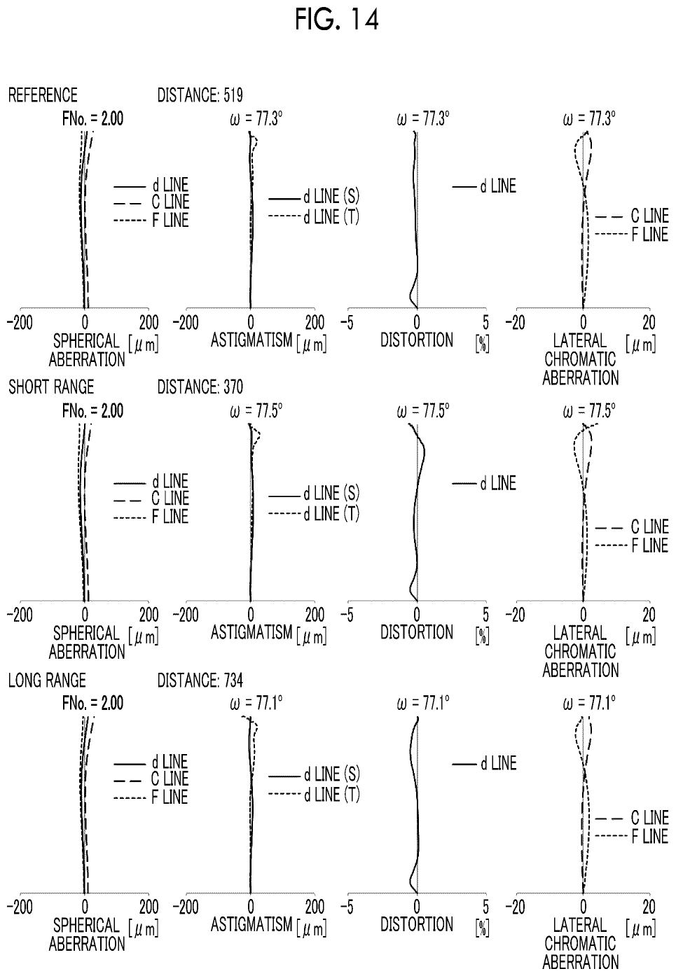

Regarding the imaging optical system according to Example 7, Table 19 shows basic lens data, Table 20 shows specifications and variable surface spacings, Table 21 shows aspherical coefficients, and FIG. 14 shows each of the aberration diagrams.

TABLE 19
Example 7

| Sn | R | D | Nd | νd | Nd + 0.01 × νd | |
|---|---|---|---|---|---|---|
| *1 | −137.0303 | −4.0010 | 1.53638 | 56.09 | 2.09728 | |
| *2 | −9994.8919 | DD[2] | | | | |
| *3 | 62.0058 | 87.8502 | | | | Reflecting Surface |
| *4 | 569.2204 | −87.8502 | | | | Reflecting Surface |
| *5 | 62.0058 | DD[5] | | | | Reflecting Surface |
| *6 | −15.6732 | 4.7847 | 1.53638 | 56.09 | 2.09728 | |
| *7 | −62.9889 | 4.9187 | | | | |
| 8 | −25.1224 | 0.8000 | 1.84666 | 23.78 | 2.08446 | |
| 9 | 41.7609 | 0.4087 | | | | |
| 10 | 46.1400 | 7.1405 | 1.59551 | 39.24 | 1.98791 | |
| 11 | −27.3716 | 0.0304 | | | | |
| 12 | 118.0968 | 3.8005 | 1.84666 | 23.78 | 2.08446 | |
| 13 | −64.6260 | DD[13] | | | | |
| 14 | 18.7644 | 4.8346 | 1.59551 | 39.24 | 1.98791 | |
| 15 | 759.2139 | 8.9423 | | | | |
| 16 | −26.7791 | 0.9991 | 1.83481 | 42.72 | 2.26201 | |
| 17 | 14.1118 | 0.0308 | | | | |
| 18 | 11.5546 | 3.3679 | 1.48749 | 70.44 | 2.19189 | |
| 19 | −21.0959 | 0.5727 | | | | |
| 20(St) | ∞ | 3.3982 | | | | |
| 21 | 36.6114 | 4.4440 | 1.48749 | 70.44 | 2.19189 | |
| 22 | −7.6779 | 6.0008 | 1.83481 | 42.72 | 2.26201 | |
| 23 | 371.3311 | 0.0308 | | | | |
| 24 | 52.6456 | 5.9573 | 1.59282 | 68.62 | 2.27902 | |
| 25 | −24.9938 | 1.9590 | | | | |
| 26 | 210.3683 | 6.9994 | 1.58913 | 61.15 | 2.20063 | |
| *27 | −15.1885 | 3.2000 | | | | |
| 28 | ∞ | 2.0000 | 1.51680 | 64.20 | | |
| 29 | ∞ | 1.0000 | | | | |
| 30 | ∞ | 20.0000 | 1.72342 | 37.95 | | |
| 31 | ∞ | 0.4000 | | | | |
| 32 | ∞ | 1.2000 | 1.48749 | 70.44 | | |
| 33 | ∞ | 0.0520 | | | | |

TABLE 20
Example 7

| | Reference | Short Range | Long Range |
|---|---|---|---|
| f | 2.08 | — | — |
| FNo. | 2.00 | — | — |
| 2ω[0] | 154.6 | — | — |
| Projection | 519 | 370 | 734 |
| Distance | | | |
| DD[2] | −82.8400 | −84.4100 | −81.9000 |
| DD[5] | 94.7500 | 96.3300 | 93.8100 |
| DD[13] | 6.7300 | 5.1600 | 7.6700 |

TABLE 21
Example 7

| Sn | 1 | 2 |
|---|---|---|
| KA | 1.0000000E+00 | 1.0000000E+00 |
| A4 | 6.4125122E−07 | −1.6359149E−06 |
| A6 | −5.9382937E−10 | 1.2851549E−10 |
| A8 | 7.7963296E−14 | −9.9141959E−14 |
| A10 | −3.9688769E−18 | 1.3392686E−17 |

| Sn | 3 | 4 | 5 |
|---|---|---|---|
| KA | −3.0432803E−01 | 9.9999994E+00 | −3.0432803E−01 |
| A3 | 6.5716337E−06 | 2.6591735E−05 | 6.5716337E−06 |
| A4 | −1.6096295E−06 | −1.1026928E−05 | −1.6096295E−06 |
| A5 | 1.2155657E−07 | 4.5528822E−07 | 1.2155657E−07 |
| A6 | −2.0943836E−09 | −4.9394515E−09 | −2.0943836E−09 |
| A7 | −9.1130495E−11 | −2.4464201E−10 | −9.1130495E−11 |
| A8 | 4.4409331E−12 | 7.4763917E−12 | 4.4409331E−12 |
| A9 | −2.9796044E−14 | 2.6011524E−14 | −2.9796044E−14 |
| A10 | −1.7818583E−15 | −3.0279917E−15 | −1.7818583E−15 |
| A11 | 3.4737411E−17 | 1.0212139E−17 | 3.4737411E−17 |
| A12 | 1.4932812E−19 | 5.9534306E−19 | 1.4932812E−19 |
| A13 | −8.6689727E−21 | −2.7785886E−21 | −8.6689727E−21 |
| A14 | 3.6789973E−23 | −5.9788071E−23 | 3.6789973E−23 |
| A15 | 6.8947524E−25 | 1.9074439E−25 | 6.8947524E−25 |
| A16 | −5.3969606E−27 | 2.5254284E−27 | −5.3969606E−27 |

| Sn | 6 | 7 | 27 |
|---|---|---|---|
| KA | 1.0000000E+00 | 1.0000000E+00 | 1.0000000E+00 |
| A4 | 2.4768996E−04 | 1.2733445E−04 | 6.5017661E−05 |
| A6 | −1.5671169E−06 | −9.9484243E−07 | −1.0778638E−08 |
| A8 | 1.1066272E−08 | 4.0558252E−09 | 4.0140517E−10 |
| A10 | −5.9100749E−11 | −3.3511669E−12 | 1.6921998E−12 |
| A12 | 2.4083898E−13 | −8.8053517E−14 | |
| A14 | −6.3192178E−16 | 5.3022179E−16 | |
| A16 | 8.9595305E−19 | −9.9536979E−19 | |

Table 22 shows the corresponding values of Conditional Expressions (1) to (5) regarding the imaging optical systems according to Examples 1 to 7. Preferable ranges of the conditional expressions may be set by using the corresponding values of the examples shown in Table 22 as the upper limits or the lower limits of the conditional expressions.

TABLE 22

| Expression | Conditional | | | | |
|---|---|---|---|---|---|
| Number | Expression | Example 1 | Example 2 | Example 3 | Example 4 |
| (1) | \|fF2B/f2\| | 2.07 | 4.43 | 2.72 | 2.35 |
| (2) | \|f1/fF2A\| | | | | |
| (3) | f2/fF1 | −0.81 | −0.57 | 0.00 | −0.02 |
| (4) | tanω | 4.45 | 5.89 | 4.54 | 4.55 |
| (5) | \|f1/f\| | 2.70 | 2.08 | 2.24 | 2.23 |

| Expression | Conditional | | | |
|---|---|---|---|---|
| Number | Expression | Example 5 | Example 6 | Example 7 |
| (1) | \|fF2B/f2\| | 1.57 | 7.96 | |
| (2) | \|f1/fF2A\| | | 0.02 | 0.04 |
| (3) | f2/fF1 | −0.38 | −0.39 | −0.10 |
| (4) | tanω | 4.54 | 4.51 | 4.42 |
| (5) | \|f1/f\| | 1.99 | 1.99 | 4.48 |

The imaging optical systems according to Examples 1 to 7 are small-sized, and the entire optical system can be made compact. In addition, the imaging optical systems according to Examples 1 to 7 have a total wide angle of view of 150 degrees or more and have a wide angle of view. In addition, in the imaging optical systems according to Examples 1 to 7, a variation in various aberrations during focusing is favorably suppressed. Accordingly, in a projection type display device on which each of the imaging optical systems according to Examples 1 to 7 is mounted, a variation in aberrations caused by a variation in projection distance is favorably suppressed, and a high projection performance can be obtained.

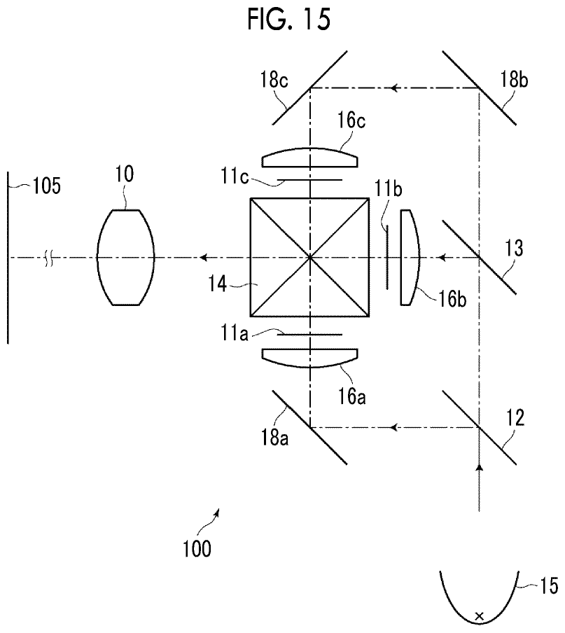

Next, a projection type display device according to an embodiment of the present disclosure will be described. FIG. 15 is a schematic configuration diagram showing the projection type display device according to an embodiment of the present disclosure. A projection type display device 100 shown in FIG. 15 includes an imaging optical system 10 according to the embodiment of the present disclosure, a light source 15, and transmissive display elements 11a to 11c as light valves corresponding to each color light and outputting an optical image. Further, the projection type display device 100 includes dichroic mirrors 12 and 13 for color separation, a cross dichroic prism 14 for color synthesis, condenser lenses 16a to 16c, and total reflection mirrors 18a to 18c for deflecting the optical path. In addition, FIG. 15 schematically shows the imaging optical system 10. Further, an integrator is disposed between the light source 15 and the dichroic mirror 12, but is not shown in FIG. 15.

White light emitted from the light source 15 is separated into three colored luminous fluxes (green light, blue light, and red light) through the dichroic mirrors 12 and 13. Next, the three colored luminous fluxes pass through the condenser lenses 16a to 16c, are incident into and modulated by the transmissive display elements 11a to 11c respectively corresponding to the respective colored luminous fluxes, are subjected to color synthesis by the cross dichroic prism 14, and are subsequently incident into the imaging optical system 10. The imaging optical system 10 projects an optical image, which is based on the modulated light modulated through the transmissive display elements 11a to 11c, onto a screen 105.

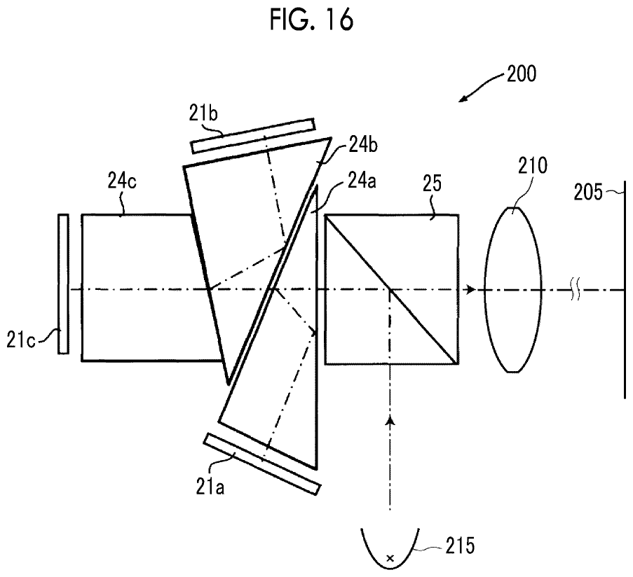

FIG. 16 is a schematic configuration diagram showing a projection type display device according to another embodiment of the present disclosure. A projection type display device 200 shown in FIG. 16 includes an imaging optical system 210 according to the embodiment of the present disclosure, a light source 215, and digital micromirror device (DMD: registered trademark) elements 21a to 21c as light valves corresponding to each color light and outputting an optical image. Further, the projection type display device 200 includes total internal reflection (TIR) prisms 24a to 24c for color separation and color synthesis, and a polarization separating prism 25 that separates illumination light and projection light. In addition, FIG. 16 schematically shows the imaging optical system 210. Further, an integrator is disposed between the light source 215 and the polarization separating prism 25, but is not shown in FIG. 16.

White light emitted from the light source 215 is reflected from a reflecting surface inside the polarization separating prism 25, and is separated into three colored luminous fluxes (green light, blue light, and red light) by the TIR prisms 24a to 24c. The separated colored luminous fluxes with the respective colors are respectively incident into and modulated through the corresponding DMD elements 21a to 21c, travel through the TIR prisms 24a to 24c again in a reverse direction, are subjected to color synthesis, are subsequently transmitted through the polarization separating prism 25, and are incident into the imaging optical system 210. The imaging optical system 210 projects an optical image, which is based on the modulated light modulated through the DMD elements 21a to 21c, onto a screen 205.

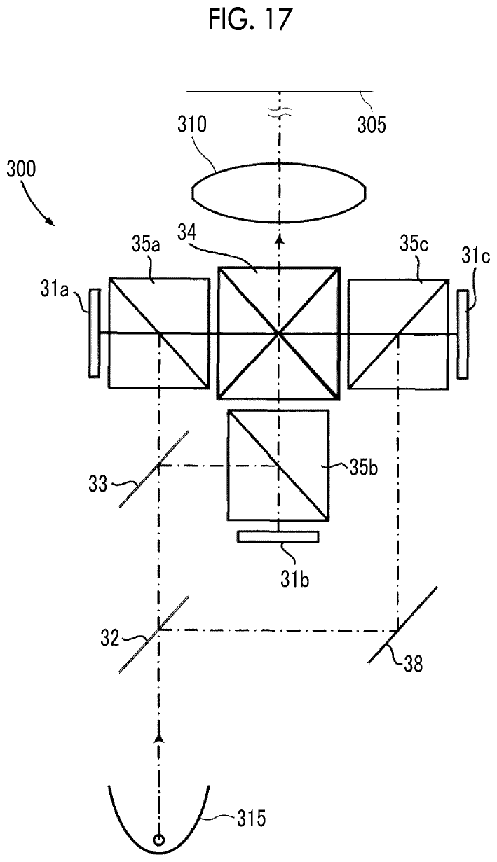

FIG. 17 is a schematic configuration diagram showing a projection type display device according to still another embodiment of the present disclosure. A projection type display device 300 shown in FIG. 17 includes an imaging optical system 310 according to the embodiment of the present disclosure, a light source 315, reflective display elements 31a to 31c as light valves each corresponding to each color light, dichroic mirrors 32 and 33 for color separation, a cross dichroic prism 34 for color synthesis, a total reflection mirror 38 for deflecting the optical path, and polarization separating prisms 35a to 35c. In addition, FIG. 17 schematically shows the imaging optical system 310. Further, an integrator is disposed between the light source 315 and the dichroic mirror 32, but is not shown in FIG. 17.

White light emitted from the light source 315 is separated into three colored luminous fluxes (green light, blue light, and red light) through the dichroic mirrors 32 and 33. The separated colored luminous fluxes with the respective colors respectively pass through the polarization separating prisms 35a to 35c, are incident into and modulated through the reflective display elements 31a to 31c respectively corresponding to the ray with the respective colors, are subjected to color synthesis through the cross dichroic prism 34, and are subsequently incident into the imaging optical system 310. The imaging optical system 310 projects an optical image, which is based on the modulated light modulated through the reflective display elements 31a to 31c, onto a screen 305.

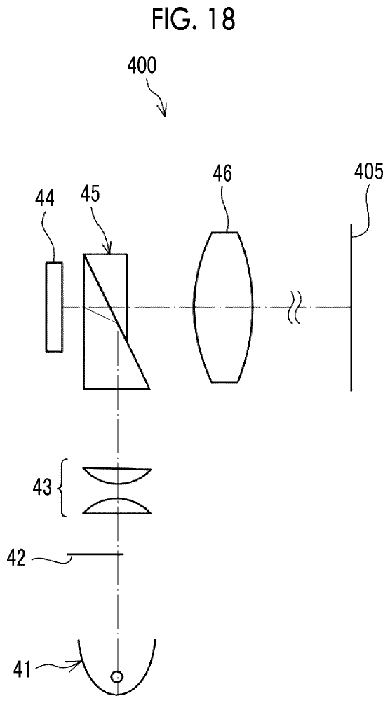

FIG. 18 is a schematic configuration diagram showing a projection type display device according to still another embodiment of the present disclosure. A projection type display device 400 shown in FIG. 18 includes an imaging optical system 46 according to the embodiment of the present disclosure, a light source 41, and a DMD element 44 as a light valve corresponding to each color light and outputting an optical image. Further, the projection type display device 400 includes a color wheel 42, a light guide optical system 43, and a TIR prism 45. In addition, FIG. 18 schematically shows the imaging optical system 46.

Filters having three colors of green, blue, and red are provided on a circumference of the color wheel 42. In a case where the color wheel 42 is rotated, the filters having the respective colors are sequentially inserted on the optical path. White light from the light source 41 is incident into the rotating color wheel 42 and is time-divided into colored luminous fluxes having three colors (green light, blue light, and red light). The colored luminous fluxes having the respective colors after the time-division pass through the light guide optical system 43 and the TIR prism 45, are incident into the DMD elements 44 to be modulated, and are incident into the imaging optical system 46 through the TIR prism 45 again. The imaging optical system 46 projects an optical image based on the modulated light modulated by the DMD element 44 onto a screen 405.

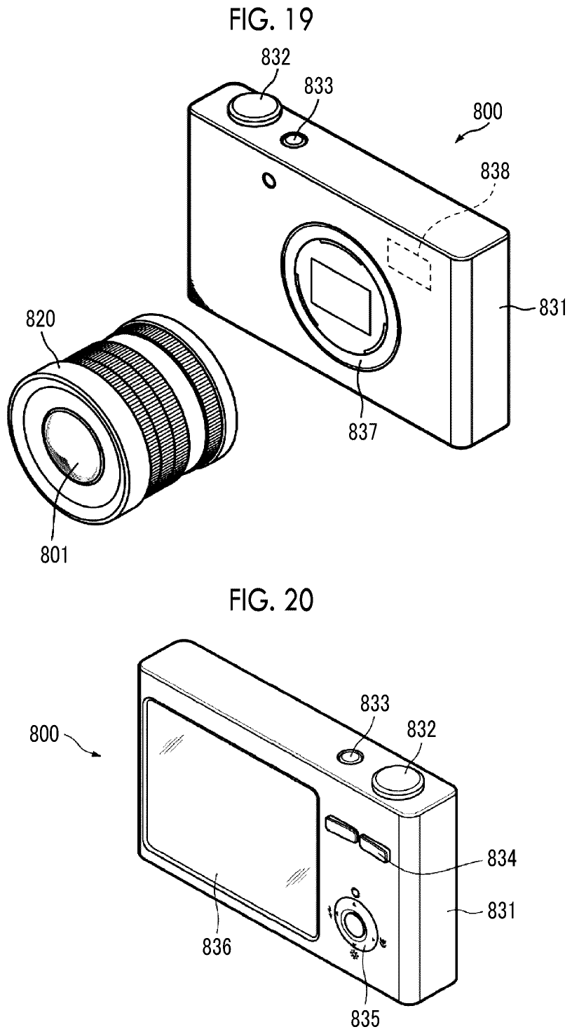

FIGS. 19 and 20 are external views showing a camera 800 that is an imaging apparatus according to an embodiment of the present disclosure. FIG. 19 is a perspective view showing the camera 800 in a view from the front side, and FIG. 20 is a perspective view showing the camera 800 in a view from the rear side. The camera 800 is a so-called mirrorless type digital camera, and an interchangeable lens 820 can be removably attached thereto. The interchangeable lens 820 is composed of an imaging optical system 801 according to an embodiment of the present disclosure accommodated in a lens barrel.

The camera 800 includes a camera body 831. A shutter button 832 and a power button 833 are provided on an upper surface of the camera body 831. Further, an operator 834, an operator 835 and a display unit 836 are provided on the rear surface of the camera body 831. The display unit 836 displays a captured image and an image within an angle of view before imaging.

An imaging aperture through which light from an imaging target is incident is provided at the center on the front surface of the camera body 831. A mount 837 is provided at a position corresponding to the imaging aperture. The interchangeable lens 820 is mounted on the camera body 831 with the mount 837 interposed therebetween.

An imaging element 838 is provided in the camera body 831. The imaging element 838 outputs an imaging signal corresponding to the subject image formed by the interchangeable lens 820. For example, a charge coupled device (CCD) or a complementary metal oxide semiconductor (CMOS) is used as the imaging element 838. A signal processing circuit (not shown), a recording medium (not shown), and the like are provided in the camera body 831. The signal processing circuit processes the imaging signal output from the imaging element 838 to generate an image. The recording medium is used to record the generated image. The camera 800 can capture a still image or a motion picture by pressing the shutter button 832, and records image data obtained through imaging in the recording medium.

The present disclosed technology has been hitherto described through the embodiments and the examples, but the present disclosed technology is not limited to the above-described embodiments and examples, and may be modified into various forms. The curvature radius of each of the reflecting surfaces and the curvature radius, the surface spacing, the refractive index, the Abbe number, the aspherical coefficient of each of the lenses are not limited to the values shown in each of the examples, and may be other values.

In addition, the projection type display device according to the present disclosed technology is not limited to the above-described configuration. For example, various changes of aspects can be made for the optical members and the light valves used for the luminous flux separation or the luminous flux synthesis. The light valve is not limited to an aspect in which light emitted from the light source is spatially modulated by an image display element and is output as an optical image based on image data, but may be an aspect in which light itself output from a light emitting image display element is output as an optical image based on the image data. Examples of the light emitting image display element include an image display element where light emitting elements such as light emitting diodes (LED) or organic light emitting diodes (OLED) are two-dimensionally arranged.

Further, an imaging apparatus according to the present disclosed technology is not limited to the above-described configuration, and may be modified into various forms such as a non-mirrorless type camera, a film camera, a video camera, a security camera, and a camera for movie imaging.

Regarding the above-described embodiments and examples, the following supplementary notes will be further disclosed.

### Supplementary Note 1

An imaging optical system comprising a reflective optical system and a refractive optical system including a plurality of lenses along an optical path in order from an enlargement side to a reduction side,
in which the reflective optical system includes a first reflecting surface having a positive power, a second reflecting surface having a power, and a third reflecting surface having a positive power along the optical path in order from the enlargement side to the reduction side,
an intermediate image conjugate to an image on a reduction-side imaging plane is formed twice on the optical path between a surface closest to the enlargement side in the refractive optical system and an enlargement-side imaging plane,
the intermediate image is re-formed on the enlargement-side imaging plane,
the imaging optical system further includes a focusing group consisting of a lens that moves during focusing from a long range to a short range, and
the first reflecting surface, the second reflecting surface, and the third reflecting surface are fixed to the reduction-side imaging plane during focusing from a long range to a short range.

### Supplementary Note 2

The imaging optical system according to Supplementary Note 1,
in which in a case where the intermediate image closest to the reduction side among the intermediate images is a first intermediate image,
a position where an off-axis principal ray and an optical axis intersect each other in the refractive optical system is a stop position, and
a focusing group closest to the enlargement side among focusing groups disposed from the first intermediate image to the stop position is a F1 focusing group,
the F1 focusing group moves from the enlargement side to the reduction side during focusing from a long range to a short range.

### Supplementary Note 3

The imaging optical system according to Supplementary Note 2, further comprising:
at least one of
a F2A focusing group that is the focusing group closest to the enlargement side among the focusing groups and is disposed closer to the enlargement side than the first reflecting surface, or
a F2B focusing group that is the focusing group closest to the reduction side among the focusing groups and is disposed closer to the reduction side than the F1 focusing group.

### Supplementary Note 4

The imaging optical system according to Supplementary Note 3, comprising:
the F2B focusing group,
in which in a case where a focal length of the F2B focusing group is represented by fF2B, and
a focal length of the refractive optical system is represented by f2, Conditional Expression (1) represented by

$$1 < \vert fF 2 B / f 2 \vert < 20 \qquad ( 1 )$$

is satisfied.

### Supplementary Note 5

The imaging optical system according to Supplementary Note 3 or 4, comprising:
the F2B focusing group,
in which a lens surface closest to the enlargement side in the F2B focusing group has a shape having a convex surface facing the enlargement side.

### Supplementary Note 6

The imaging optical system according to any one of Supplementary Notes 3 to 5, comprising:
the F2B focusing group,
in which in a case where a lens surface closest to the reduction side in the F2B focusing group is disposed closer to the enlargement side than the stop position, the F2B focusing group moves from the enlargement side to the reduction side during focusing from a long range to a short range,
in a case where a lens surface closest to the enlargement side in the F2B focusing group is disposed adjacent to the reduction side at the stop position, the F2B focusing group moves from the reduction side to the enlargement side during focusing from a long range to a short range, and
in a case where the lens surface closest to the enlargement side in the F2B focusing group is disposed closer to the reduction side than the stop position and at least one lens that is fixed to the reduction-side imaging plane during focusing from a long range to a short range is disposed between the stop position and the surface closest to the enlargement side in the F2B focusing group, the F2B focusing group moves from the enlargement side to the reduction side during focusing from a long range to a short range.

### Supplementary Note 7

The imaging optical system according to any one of Supplementary Notes 3 to 6, comprising:
the F2A focusing group,
in which in a case where a combined focal length from a surface closest to the enlargement side in the imaging optical system to a surface closest to the reduction side in the reflective optical system is represented by f1, and
a focal length of the F2A focusing group is represented by fF2A, Conditional Expression (2) represented by

$$0 < \vert f 1 / fF 2 A \vert < 1 \qquad ( 2 )$$

is satisfied.

### Supplementary Note 8

The imaging optical system according to any one of Supplementary Notes 3 to 7, comprising:
the F2A focusing group,
in which the F2A focusing group is disposed closest to the enlargement side in the imaging optical system.

### Supplementary Note 9

The imaging optical system according to any one of Supplementary Notes 3 to 8, comprising:
the F2A focusing group,
in which the F2A focusing group consists of one single lens.

### Supplementary Note 10

The imaging optical system according to Supplementary Note 9,
in which a lens surface of the single lens on the enlargement side has an aspherical shape having a convex surface facing the enlargement side.

### Supplementary Note 11

The imaging optical system according to any one of Supplementary Notes 2 to 10,
in which a lens surface closest to the enlargement side in the F1 focusing group has a shape having a concave surface facing the enlargement side in a paraxial region.

### Supplementary Note 12

The imaging optical system according to Supplementary Note 11,
in which the lens surface closest to the enlargement side in the F1 focusing group has an aspherical shape including a region where a negative power is weakened away from the optical axis.

### Supplementary Note 13

The imaging optical system according to any one of Supplementary Notes 2 to 12,
in which in a case where a focal length of the refractive optical system is represented by f2, and
a focal length of the F1 focusing group is represented by fF1, Conditional Expression (3) represented by

$$- 2 < f 2 / fF 1 < 0.5 \qquad ( 3 )$$

is satisfied.

### Supplementary Note 14

The imaging optical system according to any one of Supplementary Notes 1 to 13,
in which in a case where a maximum half angle of view of the enlargement side is represented by ω, Conditional Expression (4) represented by

$$3. 6 < tan ω \qquad ( 4 )$$

is satisfied.

### Supplementary Note 15

The imaging optical system according to any one of Supplementary Notes 1 to 14,
in which the second reflecting surface has a negative power.

### Supplementary Note 16

The imaging optical system according to any one of Supplementary Notes 1 to 15,
in which a first intermediate image is formed on the optical path between the third reflecting surface and the refractive optical system, and
a second intermediate image is formed on the optical path between the first reflecting surface and the second reflecting surface.

### Supplementary Note 17

The imaging optical system according to any one of Supplementary Notes 1 to 16,
in which in a case where a focal length of the imaging optical system is represented by f, and
a combined focal length from a surface closest to the enlargement side in the imaging optical system to a surface closest to the reduction side in the reflective optical system is represented by f1, Conditional Expression (5) represented by

$$1 < \vert f 1 / f \vert < 10 \qquad ( 5 )$$

is satisfied.

### Supplementary Note 18

The imaging optical system according to any one of Supplementary Notes 1 to 17, comprising:
only two focusing groups.

### Supplementary Note 19

The imaging optical system according to any one of Supplementary Notes 1 to 17, comprising:
three or more focusing groups.

### Supplementary Note 20

The imaging optical system according to any one of Supplementary Notes 2 to 13 and Supplement Notes 14 to 19 that depend on Supplement Note 2, comprising:
the F2A focusing group,
the F2A focusing group includes a LF2A lens, and
in a case where a refractive index of the LF2A lens with respect to a d line is represented by NF2A, and
an Abbe number of the LF2A lens with respect to the d line is represented by vF2A, Conditional Expression (6) represented by

$$2 < N F 2 A + 0.01 \times v F 2 A < 2 \text{.14} \qquad ( 6 )$$

is satisfied.

### Supplementary Note 21

The imaging optical system according to Supplementary Note 20,
in which the LF2A lens satisfies Conditional Expression (7) represented by

$$48 < v F 2 A < 57. \qquad ( 7 )$$

### Supplementary Note 22

The imaging optical system according to any one of Supplementary Notes 2 to 13 and Supplement Notes 14 to 21 that depend on Supplement Note 2,
in which the F1 focusing group includes a LF1 lens,
in a case where a refractive index of the LF1 lens with respect to the d line is represented by NLF1, and
an Abbe number of the LF1 lens with respect to a d line is represented by vLF1, Conditional Expression (8) represented by

$$2 < N L F 1 + 0.01 \times v L F 1 < 2 \text{.14} \qquad ( 8 )$$

is satisfied.

### Supplementary Note 23

The imaging optical system according to Supplementary Note 22
in which the LF1 lens satisfies Conditional Expression (9) represented by

$$48 < v L F 1 < 57. \qquad ( 9 )$$

### Supplementary Note 24

A projection type display device comprising:
the imaging optical system according to any one of Supplementary Notes 1 to 23.

### Supplementary Note 25

An imaging apparatus comprising:
the imaging optical system according to any one of Supplementary Notes 1 to 23.

What is claimed is:

1. An imaging optical system comprising a reflective optical system and a refractive optical system including a plurality of lenses along an optical path in order from an enlargement side to a reduction side, wherein:
the reflective optical system includes a first reflecting surface having a positive power, a second reflecting surface having a power, and a third reflecting surface having a positive power along the optical path in order from the enlargement side to the reduction side,
an intermediate image conjugate to an image on a reduction-side imaging plane is formed twice on the optical path between a surface closest to the enlargement side in the refractive optical system and an enlargement-side imaging plane,
the intermediate image is re-formed on the enlargement-side imaging plane,
the imaging optical system further includes a focusing group consisting of a lens that moves during focusing from a long range to a short range, and
the first reflecting surface, the second reflecting surface, and the third reflecting surface are fixed to the reduction-side imaging plane during focusing from a long range to a short range.

2. The imaging optical system according to claim 1, wherein in a case where:
the intermediate image closest to the reduction side among the intermediate images is a first intermediate image,
a position where an off-axis principal ray and an optical axis intersect each other in the refractive optical system is a stop position, and
a focusing group closest to the enlargement side among focusing groups disposed from the first intermediate image to the stop position is a F1 focusing group,
the F1 focusing group moves from the enlargement side to the reduction side during focusing from a long range to a short range.

3. The imaging optical system according to claim 2, further comprising at least one of:
a F2A focusing group that is the focusing group closest to the enlargement side among the focusing groups and is disposed closer to the enlargement side than the first reflecting surface, or
a F2B focusing group that is the focusing group closest to the reduction side among the focusing groups and is disposed closer to the reduction side than the F1 focusing group.

4. The imaging optical system according to claim 3, comprising the F2B focusing group, wherein in a case where:
a focal length of the F2B focusing group is represented by fF2B, and
a focal length of the refractive optical system is represented by f2,
Conditional Expression (1) is satisfied:
$$1 < \vert fF 2 B / f 2 \vert < 20. \qquad ( 1 )$$

5. The imaging optical system according to claim 3, comprising the F2B focusing group, wherein a lens surface closest to the enlargement side in the F2B focusing group has a shape having a convex surface facing the enlargement side.

6. The imaging optical system according to claim 3, comprising the F2B focusing group, wherein:
in a case where a lens surface closest to the reduction side in the F2B focusing group is disposed closer to the enlargement side than the stop position, the F2B focusing group moves from the enlargement side to the reduction side during focusing from a long range to a short range,
in a case where a lens surface closest to the enlargement side in the F2B focusing group is disposed adjacent to the reduction side at the stop position, the F2B focusing group moves from the reduction side to the enlargement side during focusing from a long range to a short range, and
in a case where the lens surface closest to the enlargement side in the F2B focusing group is disposed closer to the reduction side than the stop position and at least one lens that is fixed to the reduction-side imaging plane during focusing from a long range to a short range is disposed between the stop position and the surface closest to the enlargement side in the F2B focusing group, the F2B focusing group moves from the enlargement side to the reduction side during focusing from a long range to a short range.

7. The imaging optical system according to claim 3, comprising the F2A focusing group, wherein in a case where:
a combined focal length from a surface closest to the enlargement side in the imaging optical system to a surface closest to the reduction side in the reflective optical system is represented by f1, and
a focal length of the F2A focusing group is represented by fF2A,
Conditional Expression (2) is satisfied:
$$0 < \vert f 1 / fF 2 A \vert < 1 . \qquad ( 2 )$$

8. The imaging optical system according to claim 3, comprising the F2A focusing group, wherein:
the F2A focusing group is disposed closest to the enlargement side in the imaging optical system.

9. The imaging optical system according to claim 3, comprising the F2A focusing group, wherein:
the F2A focusing group consists of one single lens.

10. The imaging optical system according to claim 9, wherein a lens surface of the single lens on the enlargement side has an aspherical shape having a convex surface facing the enlargement side.

11. The imaging optical system according to claim 2, wherein a lens surface closest to the enlargement side in the F1 focusing group has a shape having a concave surface facing the enlargement side in a paraxial region.

12. The imaging optical system according to claim 11, wherein the lens surface closest to the enlargement side in the F1 focusing group has an aspherical shape including a region where a negative power is weakened away from the optical axis.

13. The imaging optical system according to claim 2, wherein in a case where:
a focal length of the refractive optical system is represented by f2, and
a focal length of the F1 focusing group is represented by fF1,
Conditional Expression (3) is satisfied:
$$- 2 < f 2 / fF 1 < 0.5 . \qquad ( 3 )$$

14. The imaging optical system according to claim 1, wherein in a case where:
a maximum half angle of view of the enlargement side is represented by ω,
Conditional Expression (4) is satisfied:
$$3. 6 < tan ω . \qquad ( 4 )$$

15. The imaging optical system according to claim 1, wherein the second reflecting surface has a negative power.

16. The imaging optical system according to claim 1, wherein:
a first intermediate image is formed on the optical path between the third reflecting surface and the refractive optical system, and
a second intermediate image is formed on the optical path between the first reflecting surface and the second reflecting surface.

17. The imaging optical system according to claim 1, wherein in a case where:
a focal length of the imaging optical system is represented by f, and
a combined focal length from a surface closest to the enlargement side in the imaging optical system to a surface closest to the reduction side in the reflective optical system is represented by f1,
Conditional Expression (5) is satisfied:
$$1 < \vert f 1 / f \vert < 10. \qquad ( 5 )$$

18. The imaging optical system according to claim 1, comprising only two focusing groups.

19. A projection type display device comprising the imaging optical system according to claim 1.

20. An imaging apparatus comprising the imaging optical system according to claim 1.
